(19) United States
(12) Patent Application Publication
(10) Pub. No.: US 2026/0337455 A1
(43) Pub. Date: Oct. 29, 2026

(54) RESIN COMPOSITION, ADHESIVE MEMBER, AND ELECTRONIC DEVICE

(71) Applicant: Samsung Display Co., Ltd., Yongin-si (KR)

(72) Inventor: Keisuke MORITA, Yokohama-shi (JP)

(21) Appl. No.: 19/658,463

(22) Filed: Apr. 24, 2026

(30) Foreign Application Priority Data
Apr. 28, 2025 (JP) 2025-074947

(51) Int. Cl. C09J 4/06; C09J 133/06; C09J 133/14; H01B 3/30

(52) U.S. Cl. CPC C09J 4/06; C09J 133/066; C09J 133/068; C09J 133/14; H01B 3/307

(57) ABSTRACT

A resin composition, an adhesive member, and an electronic device are provided. The resin composition may include a (meth)acrylate copolymer, a monofunctional (meth)acrylate monomer, a photoradical polymerization initiator, and a photocationic polymerization initiator. The (meth)acrylate copolymer included in the resin composition is a copolymer of a cationically reactive (meth)acrylate monomer containing an epoxy group or an oxetane group, and a non-cationically reactive (meth)acrylate monomer, and may be polymerized by including a cationically reactive (meth)acrylate monomer containing an epoxy group in a specific content (e.g., amount) range.

### CROSS-REFERENCE TO RELATED APPLICATION

The present application claims priority to and the benefit of Japanese Patent Application No. 2025-074947, filed on Apr. 28, 2025, in the Japan Patent Office, the entire content of which is incorporated herein by reference.

### BACKGROUND

### 1. Field

One or more embodiments of the present disclosure relate to (i) a resin composition, (ii) an adhesive member, and (iii) an electronic device. For example, one or more embodiments of the present disclosure particularly relate to (i) a resin composition, (ii) an adhesive member formed from the resin composition, and (iii) an electronic device including the adhesive member.

### 2. Description of Related Art

Various types (kinds) of display devices have been developed for applications in multimedia electronic devices, such as television sets, mobile phones, tablets, computers, navigation systems, and/or game consoles. Recently, development efforts have been focused on display devices that include stepped portions due to the application of electronic modules with various functions and/or new designs that incorporate printing layers. In addition, display devices equipped with flexible display members that enable folding, bending, and/or rolling are being developed to improve user convenience. Adhesive resins have been used to form adhesive layers (or adhesive members) applied to these display devices, and they are desired or required to provide strong and reliable adhesion to different components/members included in the display devices.

### SUMMARY

One or more aspects of embodiments of the present disclosure are directed toward a resin composition capable of exhibiting excellent or suitable adhesive properties even during photocuring in an air atmosphere.

One or more aspects of embodiments of the present disclosure are directed toward an electronic device that has improved reliability, achieved by bonding substrates included in the electronic device via an adhesive member that exhibits excellent or suitable adhesion even in room temperature, high-temperature, and high-temperature and high-humidity environments.

Additional aspects will be set forth in part in the description which follows and, in part, will be apparent from the description, or may be learned by practice of the presented embodiments.

According to one or more embodiments of the present disclosure, a resin composition includes a (meth)acrylate copolymer, which is a first copolymer or a second copolymer, a monofunctional (meth)acrylate monomer, a photoradical polymerization initiator, and a photocationic polymerization initiator. The first copolymer is a copolymer of (e.g., polymerized by including) a first monomer which is a cationically reactive (meth)acrylate monomer containing an epoxy group and a third monomer which is a non-cationically reactive (meth)acrylate monomer, the second copolymer is a copolymer of (e.g., polymerized by including) a second monomer which is a cationically reactive (meth)acrylate monomer containing an oxetane group, and the third monomer, the first copolymer is a copolymer of (e.g., polymerized by including) the first monomer in an amount of about 1 part to about 30 parts by mass with respect to 100 parts by mass of a total of the first monomer and the third monomer, and the resin composition does not include any cationically reactive compound other than the first monomer or the second monomer included in the polymerization of the (meth)acrylate copolymer.

In one or more embodiments, the (meth)acrylate copolymer may have a weight average molecular weight of about 3,000 to about 30,000.

In one or more embodiments, the first monomer may include at least one of glycidyl methacrylate, glycidyl acrylate, (3,4-epoxycyclohexyl)methyl acrylate, or (3,4-epoxycyclohexyl)methyl methacrylate, and the second monomer may include at least one of (3-ethyloxetan-3-yl)methyl acrylate or (3-ethyloxetan-3-yl)methyl methacrylate.

In one or more embodiments, the third monomer may include at least one of methyl methacrylate or isobornyl methacrylate.

In one or more embodiments, the first copolymer may be a copolymer of (e.g., polymerized by including) the first monomer, methyl methacrylate, and isobornyl methacrylate.

In one or more embodiments, the first monomer may be glycidyl methacrylate or (3,4-epoxycyclohexyl)methyl methacrylate.

In one or more embodiments, the second copolymer may be a copolymer of (e.g., polymerized by including) the second monomer, methyl methacrylate, and isobornyl methacrylate.

In one or more embodiments, the second monomer may be (3-ethyloxetan-3-yl)methyl methacrylate.

In one or more embodiments, the monofunctional (meth)acrylate monomer may include at least one of 4-hydroxybutylacrylate, 2-ethylhexylacrylate, or tetrahydrofurfuryl acrylate.

In one or more embodiments, the photocationic polymerization initiator may include a borate and/or a sulfonate.

According to one or more embodiments of the present disclosure, provided is an adhesive member derived (e.g., formed) from a resin composition cured by light irradiation in an air atmosphere.

In one or more embodiments, the adhesive member may have a 180° peel strength of about 800 gf/25 mm or greater for at least one of a glass substrate or a polymer substrate at a temperature of about 25 °C.

In one or more embodiments, the adhesive member may have a 180° peel strength of about 200 gf/25 mm or greater for at least one of a glass substrate or a polymer substrate at a temperature of about 60 °C.

In one or more embodiments, the adhesive member may have a 180° peel strength of about 100 gf/25 mm or greater for at least one of a glass substrate or a polymer substrate at a temperature of about 85 °C and a relative humidity of about 85%.

According to one or more embodiments of the present disclosure, an electronic device includes a display device including at least one adhesive member derived (e.g., formed) from the resin composition described herein.

In one or more embodiments, the display device may further include a display panel configured to display images and a window on (e.g., arranged on) the display panel, and the adhesive member may be between (e.g., arranged between) the display panel and the window.

In one or more embodiments, for example, the electronic device may be at least one of a television, a monitor, an outdoor billboard, a personal computer, a laptop computer, a personal digital terminal, an in-vehicle device, a game console, a smartphone, a tablet, a smartwatch, or a camera.

In one or more embodiments, the resin composition includes a (meth)acrylate copolymer that is either (i) a copolymer of a first monomer which is a cationically reactive (meth)acrylate monomer containing an epoxy group and a third monomer which is a non-cationically reactive (meth)acrylate monomer, or (ii) a copolymer of a second monomer which is a cationically reactive (meth)acrylate monomer containing an oxetane group and the third monomer; the copolymer may have a weight-average molecular weight of about 3,000 to about 30,000, the first monomer content in the epoxy-based copolymer may be about 1 part to about 30 parts by mass per 100 parts by mass of the total of the first monomer and the third monomer, and the resin composition further comprises a monofunctional (meth)acrylate monomer, a photoradical polymerization initiator, and a photocationic polymerization initiator (e.g., a borate or a sulfonate), while excluding any additional cationically reactive compound other than the first monomer or the second monomer included in polymerization of the (meth)acrylate copolymer; when photocured in an oxygen-containing atmosphere, the composition yields an adhesive member derived therefrom that exhibits 180° peel strengths meeting or exceeding about 800 gf/25 mm at about 25 °C, about 200 gf/25 mm at about 60 °C, and about 100 gf/25 mm at about 85 °C and about 85% relative humidity, and an electronic device may incorporate at least one such adhesive member between a display panel and a window to provide improved reliability across room-temperature, high-temperature, and high-temperature/high-humidity environments.

### BRIEF DESCRIPTION OF THE FIGURES

The accompanying drawings are included to provide a further understanding of the present disclosure, and are incorporated in and constitute a part of this disclosure. The drawings illustrate embodiments of the present disclosure and, together with the description, serve to explain principles of the disclosure. Above and/or other aspects of the disclosure should become apparent and appreciated from the following description of embodiments taken in conjunction with the accompanying drawings. In the drawings:

FIG. 1 is a block diagram of an electronic device according to one or more embodiments of the present disclosure;

FIG. 2 shows schematic views of electronic devices according to one or more embodiments of the present disclosure;

FIG. 3A is a perspective view showing an electronic device according to one or more embodiments of the present disclosure;

FIG. 3B is a perspective view showing an electronic device according to one or more embodiments of the present disclosure;

FIG. 4 is an exploded perspective view of an electronic device according to one or more embodiments of the present disclosure;

FIG. 5 is a cross-sectional view showing a portion of a display device according to one or more embodiments of the present disclosure;

FIGS. 6A-6C are views for describing steps of forming an adhesive member included in an electronic device according to one or more embodiments of the present disclosure;

FIG. 7 is a cross-sectional view showing a display device according to one or more embodiments of the present disclosure; and

FIG. 8 is a cross-sectional view showing a display device according to one or more embodiments of the present disclosure.

### DETAILED DESCRIPTION

Embodiments of the present disclosure may be modified in many alternate forms, and thus specific embodiments will be exemplified in the drawings and described in more detail. It should be understood, however, that it is not intended to limit the present disclosure to the particular forms disclosed, but rather, is intended to cover all modifications, equivalents, and alternatives falling within the spirit and scope of the present disclosure.

In this disclosure, it will be understood that if (e.g., when) an element (or a region, a layer, a portion, and/or the like) is referred to as being “on”, “connected to”, or “coupled to” another element, it may be directly arranged on, connected to, or coupled to the other element, or one or more other elements may be arranged therebetween. In contrast, “directly on” may refer to that there are no additional intervening elements or layers between the element or layer and the other element or layer. In addition, if (e.g., when) a layer, a film, a region, a plate, and/or the like is referred to as being “under” or “below” another part, it may be “directly under” the other part, or one or more intervening layers may be present therebetween. Also, if (e.g., when) an element is referred to as being arranged “on” another element, it may be arranged under the other element.

Like reference numerals or symbols refer to like elements throughout the disclosure, and duplicative descriptions thereof may not be provided for conciseness. In the drawings, the thickness, ratio, and size of the elements may be exaggerated or reduced for effectively describing the technical content. As used herein, the term “and/or” or “or” or “/” includes any and all combinations of one or more of the associated listed elements.

It will be understood that, although the terms “first”, “second”, and/or the like may be used herein to describe one or more suitable elements, the elements are not to be limited by these terms. These terms are only used to distinguish one element from another element. For instance, a first element could be termed a second element without departing from the scope of the disclosure. Similarly, a second element could be termed a first element. In this disclosure, the singular expressions “a”, “an”, and “the” are intended to include the plural forms as well, unless the context clearly indicates otherwise. Further, the use of “may” when describing embodiments of the present disclosure refers to “one or more embodiments of the present disclosure.”

In addition, the terms “below”, “under”, “on the lower side”, “above”, “over”, “on the upper side”, and/or the like may be used to describe the relationships between the elements illustrated in the drawings. These terms are relative concepts and are described on the basis of the directions indicated in the drawings.

It will be further understood that the terms “comprise(s)/comprising,” “include(s)/including,” and/or “has (have)/having”, if (e.g., when) used in this disclosure, specify the presence of stated features, numbers, steps, operations, elements, components, or combinations thereof, but do not preclude the possibility of the presence or addition of one or more other features, numbers, steps, operations, elements, components, and/or combinations thereof. Additionally, the terms “comprise(s)/comprising,” “include(s)/including,” “has (have)/having,” or other similar terms include or support the terms “consisting of” and “consisting essentially of,” indicating the presence of stated features, numbers, steps, operations, components, parts, or combinations thereof, without or essentially without the presence of other features, numbers, steps, operations, components, parts, or combinations thereof.

As used herein, being “arranged directly on” may indicate that there is no additional layer, film, region, plate, and/or the like between a part and another part such as a layer, a film, a region, a plate, and/or the like. For example, being “arranged directly on” may indicate that two layers or two members are arranged without an additional member, such as an adhesive member, therebetween.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, one or more embodiments of the disclosure will be described with reference to the accompanying drawings.

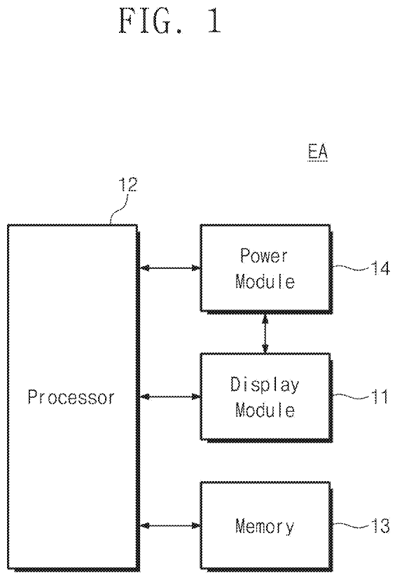

FIG. 1 is a block diagram of an electronic device according to one or more embodiments of the present disclosure. Referring to FIG. 1, an electronic device EA according to one or more embodiments may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The memory 13 may store data information desired or required for operations of the processor 12 and/or the display module 11. When the processor 12 executes an application stored in the memory 13, image data signals and/or input control signals are transmitted to the display module 11, and the display module 11 may process the received signals and output image information through a display screen. The display module 11 may include a display panel that displays an image.

The power module 14 may include a power supply module such as a power adapter or a battery device, and a power conversion module that converts power supplied by the power supply module to generate power desired or required for operations of the electronic device EA.

At least one of the components of the electronic device EA described above may be included in a display panel according to one or more embodiments, which will be described later, and a display device according to one or more embodiments including the display panel. In one or more embodiments, some of the individual modules functionally included in one module may be included in the display device, and others may be separately provided from the display device. For example, the display device may include a display module 11, and the processor 12, the memory 13 and the power module 14 may be provided in the form of other devices within the electronic device EA, rather than the display device.

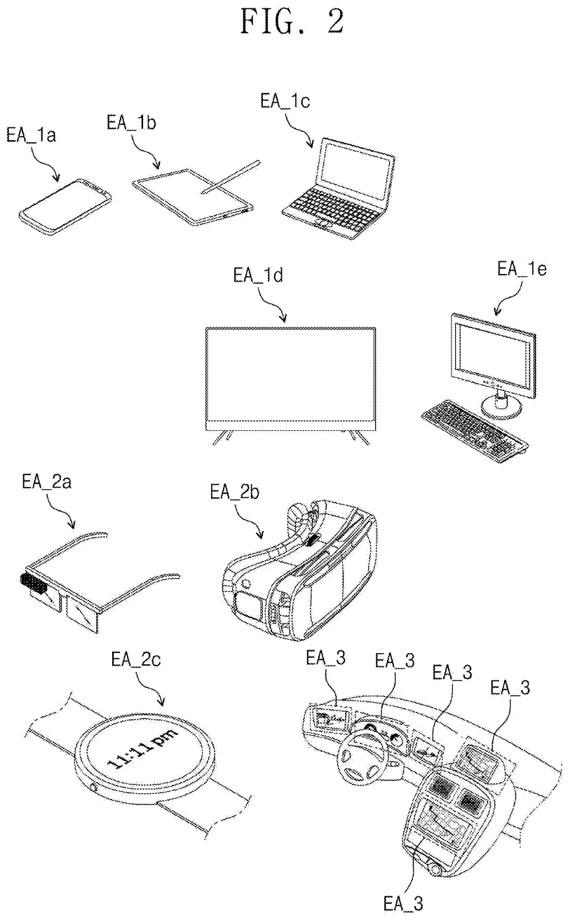

FIG. 2 shows schematic views of electronic devices according to one or more embodiments of the present disclosure.

Referring to FIG. 2, one or more suitable electronic devices including a display device according to one or more embodiments may include electronic devices for displaying images, such as a smart phone EA_1a, a tablet PC EA_1b, a laptop EA_1c, a TV EA_1d, and a desk monitor EA_1e, wearable electronic devices such as smart glasses EA_2a, a head mounted display EA_2b, and a smart watch EA_2c, and vehicle electronic devices EA_3 such as a center information display (CID) arranged on an instrument panel, a center fascia, or a dashboard of a vehicle, and a room mirror display of a vehicle.

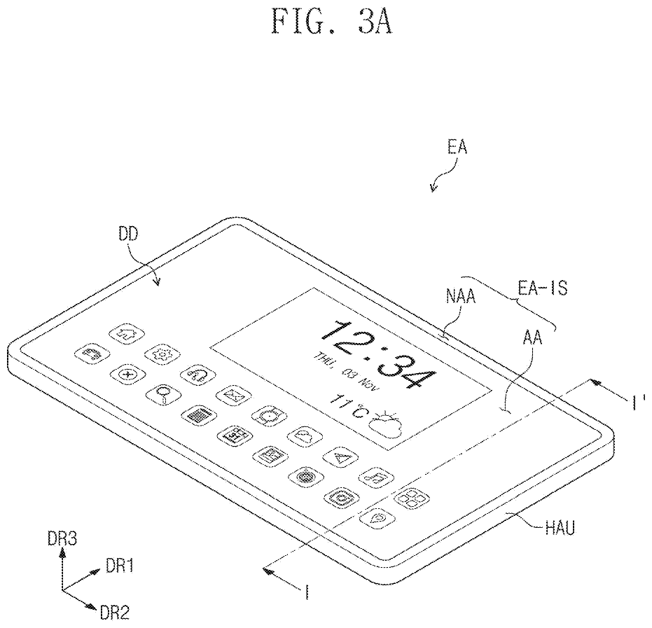

FIGS. 3A and 3B are perspective views each showing an electronic device according to one or more embodiments of the present disclosure. FIG. 3A shows a tablet terminal as an example of the electronic device EA according to one or more embodiments. FIG. 3B shows a smartphone as an example of an electronic device EA-1 according to one or more embodiments.

Referring to FIG. 3A, the tablet terminal may be formed by placing electronic modules, camera modules, power modules, and/or the like mounted on a motherboard in a bracket/housing HAU along with a display device DD.

In FIG. 3A, according to one or more embodiments, an electronic device EA including a display device DD may be provided with a flat display surface, but embodiments of the present are not limited thereto. As shown in FIG. 3B, in one or more embodiments, an electronic device EA-1 may include a curved display surface or a three-dimensional display surface. For example, the three-dimensional display surface may include a plurality of display regions indicating different directions, and may also include a bent display surface. The electronic device EA-1 according to one or more embodiments may be a flexible electronic device. The flexible electronic device may be a foldable electronic device.

The display device DD may include a display surface EA-IS defined by a first directional axis DR1 and a second directional axis DR2 crossing the first directional axis DR1. The display device DD may provide images to users through the display surface EA-IS. The display device DD may display images toward a third directional axis DR3 on the display surface EA-IS parallel to each of the first directional axis DR1 and the second directional axis DR2.

Herein, the first directional axis DR1 and the second directional axis DR2 may be perpendicular to each other, and the third directional axis DR3 may be a normal direction to a plane defined by the first directional axis DR1 and the second directional axis DR2. A thickness direction of the display device DD may be parallel to the third directional axis DR3. A front surface (or upper surface) and a rear surface (or lower surface) may oppose each other, and a normal direction of each of the front surface (or upper surface) and the rear surface (or lower surface) may be parallel to the third directional axis DR3. The term “cross-section” refers to a surface parallel to the thickness direction DR3, and the term “plane” refers to a surface perpendicular to the thickness direction DR3. The plane indicates a plane defined by the first directional axis DR1 and the second directional axis DR2. Directions indicated by the first to third directional axes DR1, DR2, and DR3 as described herein are relative concepts, and may thus be changed to other directions. In addition, the directions indicated by the first to third directional axes DR1, DR2, and DR3 may be described as first to third directions, and the same reference signs may be used. The term “on a plane” or “in plan view” used herein may be defined as being in a state if (e.g., when) viewed in the third directional axis DR3. For example, the term “on a plane” may be described on the basis of a plane defined by the first directional axis DR1 and the second directional axis DR2 together. The term “on a cross-section” or “cross-sectional view” used herein may be defined as being in a state if (e.g., when) viewed in a direction normal to the third directional axis DR3, for example, from the first directional axis DR1 or the second directional axis DR2.

As shown in FIG. 3A, the display surface EA-IS may include a display region AA where images are displayed and a non-display region NAA adjacent to the display region AA. The non-display region NAA is a region where images are not displayed. In FIG. 3A, icon images are shown as an example of images.

Referring to FIG. 3B, the electronic device EA-1 according to one or more embodiments may include a plurality of display surfaces. The electronic device EA-1 according to one or more embodiments may include display surfaces IS-M, IS-S1, IS-S2, IS-S3, and IS-S4 with different primary display directions.

In one or more embodiments, the electronic device EA-1 may be a stereoscopic electronic device including an upper display surface IS-M and a plurality of side display surfaces IS-S1, IS-S2, IS-S3, and IS-S4. Each of the side display surfaces IS-S1, IS-S2, IS-S3, and IS-S4 may be a display surface extending from one side of the upper display surface IS-M. In one or more embodiments, the electronic device EA-1 may include a main display surface that primarily displays images in one direction and a plurality of sub-display surfaces that display images in a direction different from the direction that the main display surface display images. In one or more embodiments of the electronic device EA-1 shown in FIG. 3B, the primary display surface may be the upper display surface IS-M, and the sub-display surfaces may be the side display surfaces IS-S1, IS-S2, IS-S3, and IS-S4.

The side display surfaces IS-S1, IS-S2, IS-S3, and IS-S4 may each have a display surface that is not parallel to the upper display surface IS-M. In one or more embodiments, the plurality of side display surfaces IS-S1, IS-S2, IS-S3, and IS-S4 may be display regions that are each bent and extended from one side of the upper display surface IS-M. For example, the plurality of side display surfaces IS-S1, IS-S2, IS-S3, and IS-S4 may be bending display regions. In FIG. 3B, first to fourth display surfaces IS-S1, IS-S2, IS-S3, and IS-S4 are each bent from one of the four sides of the upper display surface IS-M, but unlike what is shown, in one or more embodiments, some of the first to fourth display surfaces IS-S1, IS-S2, IS-S3, and IS-S4 may not be provided.

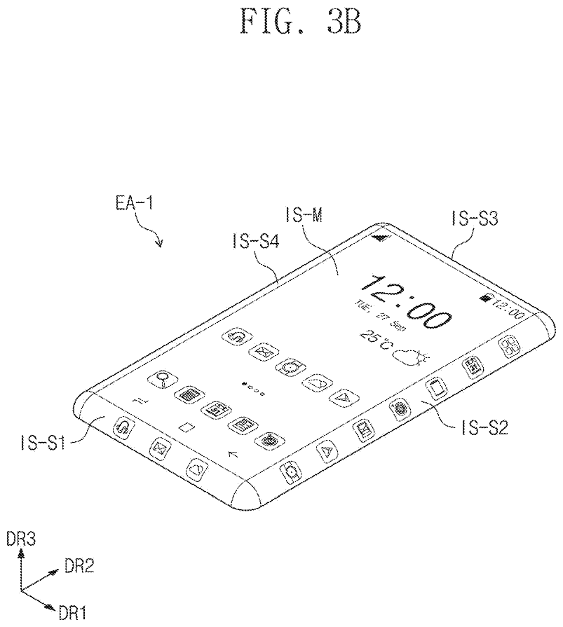

FIG. 4 is an exploded perspective view of an electronic device according to one or more embodiments of the present disclosure. FIG. 4 may be an exploded perspective view of the electronic device EA shown in FIG. 3A.

Referring to FIG. 3A and FIG. 4, the electronic device EA may include a display device DD and a housing HAU. The display device DD according to one or more embodiments may include a display module DM, a window WP, and an adhesive member AP. The display device DD may be a portion of the electronic device EA that provides images. The display device DD shown in FIG. 4 may be applied to the electronic device EA-1 of FIG. 3B. The housing HAU may accommodate the display module DM.

In the electronic device EA shown in FIG. 4, the window WP and the housing HAU may be bonded together to form an outer portion of the electronic device EA. The housing HAU may be arranged below the display module DM. In one or more embodiments, the housing HAU may include a material having a high rigidity. For example, the housing HAU may include a plurality of frames and/or plates formed of glass, plastic, or metal. The housing HAU may provide a prescribed place for accommodation. The display module DM may be accommodated in an accommodation space of the housing HAU, and may thus be protected from an external impact.

The display module DM may be activated according to electrical signals. The display module DM may be a portion that substantially provides images. An active region AA-DM may be a region activated according to electrical signals. The active region AA-DM may be a region corresponding to the display region AA of the electronic device EA, and may overlap the display region AA when viewed on a plane (e.g., in plan view). A peripheral region NAA-DM may be a region adjacent to at least one side of the active region AA-DM. Circuits or lines for driving the display module DM may be arranged in the peripheral region NAA-DM. The peripheral region NAA-DM may be a region corresponding to the non-display region NAA of the electronic device EA, and may not overlap the display region AA when viewed on a plane.

The adhesive member AP may be formed from a resin composition according to one or more embodiments of the present disclosure. The adhesive member AP may be a cured product of the resin composition cured by light irradiation. The adhesive member AP may include a polymer derived from the resin composition. The resin composition according to one or more embodiments will be described later.

The adhesive member AP may be provided between adjacent members arranged in the display device DD to bond the adjacent members to each other. For example, in one or more embodiments, the display module DM and the window WP may be bonded through the adhesive member AP. The adhesive member AP may be in contact with a lower surface of the window WP and an upper surface of the display module DM. At least one adhesive member AP may be provided within the display device DD.

The adhesive member AP may exhibit excellent or suitable adhesive properties without degradation in adhesion to adjacent members at room temperature and also in high-temperature and high-humidity environments. For example, the adhesive member AP may exhibit excellent or suitable adhesive properties without degradation in adhesion to the window WP and the display module DM even at room temperature of about 25 °C, a high temperatures of about 60 °C to about 85 °C, and a relative humidity (RH) of about 85%.

The window WP may include a transmission region TA and a bezel region BZA. The transmission region TA may overlap at least a portion of the active region AA-DM of the display module DM. The transmission region TA may be an optically transparent region. The transmission region TA may be a region corresponding to the active region AA-DM. Images generated from the display module DM may be provided to users through the transmission region TA.

The bezel region BZA may be a region having a relatively lower light transmittance than the transmission region TA. The bezel region BZA may define a shape of the transmission region TA. In one or more embodiments, the bezel region BZA may be adjacent to the transmission region TA and may surround the transmission region TA.

The bezel region BZA may have a prescribed or set color. The bezel region BZA covers the peripheral region NAA-DM of the display module DM, and may thus prevent or reduce the peripheral region NAA-DM from being viewed from the outside. However, embodiments of the present disclosure are not limited thereto, for example, in one or more embodiments, the bezel region BZA may be arranged adjacent to only one side of the transmission region TA, and at least a portion thereof may not be provided.

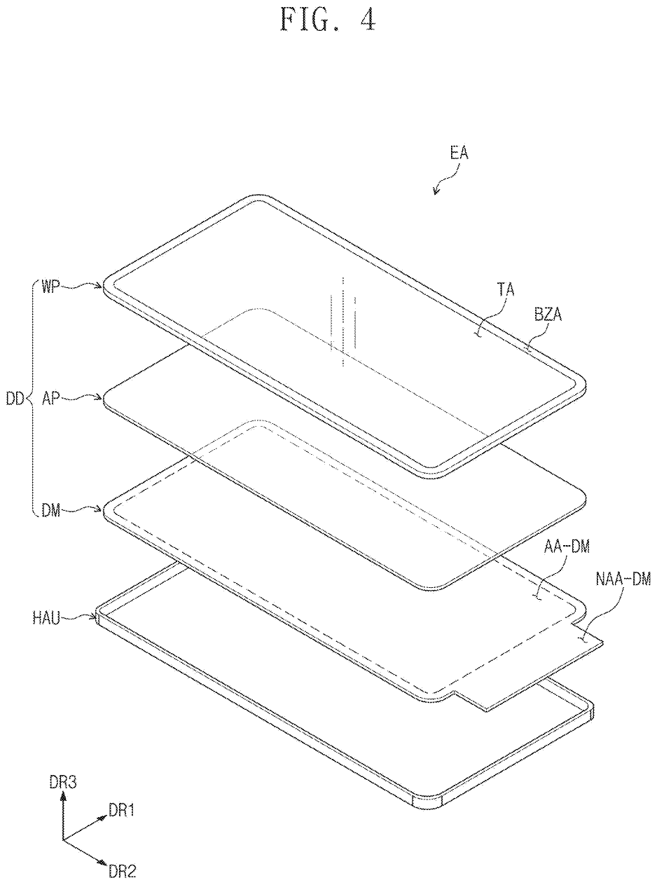

FIG. 5 is a cross-sectional view showing a portion of a display device according to one or more embodiments of the present disclosure. FIG. 5 is a cross-sectional view showing a portion corresponding to the line I-I′ of FIG. 3A according to one or more embodiments. The display device DD according to one or more embodiments may be included in the electronic device EA described above. The display device DD may be a portion of the electronic device EA that provides images. The display device DD shown in FIG. 5 may be applied to the electronic device EA-1 of FIG. 3B.

Referring to FIG. 5, the display module DM may include a display panel DP and an input sensing portion TP arranged on the display panel DP. The display panel DP may include a base substrate BS, a circuit layer DP-CL arranged on the base substrate BS, a display element layer DP-EL arranged on the circuit layer DP-CL, and an encapsulation layer TFE covering the display element layer DP-EL. The adhesive member AP may be arranged between the display module DM and the window WP.

The components of the display panel DP shown in FIG. 5 are an example and the components of the display panel DP are not limited thereto. For example, in one or more embodiments, the display panel DP may include a liquid crystal display element, and in these embodiments, the encapsulation layer TFE may not be provided.

The base substrate BS may provide a base surface on which the circuit layer DP-CL is arranged. In one or more embodiments, the base substrate BS may be a flexible substrate that is bendable, foldable, rollable, and/or the like. The base substrate BS may be a glass substrate, a metal substrate, or a polymer substrate. However, embodiments of the present disclosure are not limited thereto, and the base substrate BS may be an inorganic layer, an organic layer, or a composite material layer.

The circuit layer DP-CL may include an insulating layer, a semiconductor pattern, a conductive pattern, a signal line, and/or the like. For example, the circuit layer DP-CL may include switching transistor(s) and driving transistor(s) for driving a light emitting element of the display element layer DP-EL.

The display element layer DP-EL may include a light emitting element configured to emit light. For example, the light emitting element may include an organic light emitting material, an inorganic light emitting material, an organic-inorganic light emitting material, a quantum dot, a quantum rod, a micro LED, or a nano LED.

The encapsulation layer TFE may be arranged above (e.g., on) the display element layer DP-EL. The encapsulation layer TFE may serve to protect the display element layer DP-EL from moisture, oxygen, and/or foreign substances such as dust particles. In one or more embodiments, the encapsulation layer TFE may include at least one inorganic layer. In one or more embodiments, the encapsulation layer TFE may include at least one organic layer and at least one inorganic layer. For example, in one or more embodiments, the encapsulation layer TFE may include an inorganic layer, an organic layer, and an inorganic layer, which are sequentially stacked.

The input sensing portion TP may be arranged on the display panel DP. For example, in one or more embodiments, the input sensing portion TP may be directly arranged on the encapsulation layer TFE of the display panel DP. The input sensing portion TP may sense external inputs to convert the inputs into prescribed input signals, and provide the input signals to the display panel DP. For example, in the display device DD according to one or more embodiments, the input sensing portion TP may be a touch sensing portion sensing a touch. The input sensing portion TP may recognize a user's direct touch, a user's indirect touch, a direct touch of an object, or an indirect touch of an object.

The input sensing portion TP may sense at least one of a location of a touch or a strength (pressure) of a touch applied from the outside. In one or more embodiments, the input sensing portion TP may have one or more suitable structures or be formed of one or more suitable materials, and embodiments of the present disclosure are not limited thereto. The input sensing portion TP may include a plurality of sensing electrodes for sensing external inputs. In one or more embodiments, the sensing electrodes may sense external inputs in a capacitive manner. The display panel DP may receive input signals from the input sensing portion TP and generate images corresponding to the input signals.

The window WP may include a base layer BL and a printing layer BM. In one or more embodiments, the window WP may further include at least one functional layer provided on the base layer BL. For example, the functional layer may be a hard coating layer, an anti-fingerprint coating layer, and/or the like, but embodiments of the present disclosure are not limited thereto.

In one or more embodiments, the base layer BL may be a glass substrate. In one or more embodiments, the base layer BL may be a plastic substrate. For example, the base layer BL may be formed of polyimide, polyacrylate, polymethylmethacrylate, polycarbonate, polyethylenenaphthalate, polyvinylidene chloride, polyvinylidene difluoride, polystyrene, an ethylene vinylalcohol copolymer, or a combination thereof.

The printing layer BM may be arranged on a (e.g., one) surface of the base layer BL. The printing layer BM may be provided on a lower surface of the base layer BL adjacent to the display module DM. The printing layer BM may be arranged on an edge region of the base layer BL. In one or more embodiments, the printing layer BM may be an ink printing layer. In one or more embodiments, the printing layer BM may be a layer formed by including a pigment and/or a dye. In the window WP, the bezel region BZA (FIG. 4) may be a portion in which the printing layer BM is provided.

The adhesive member AP may be arranged below the window WP. In the window WP, a step SP-a may be present between the base layer BL on which the printing layer BM is not provided and the printing layer BM. The adhesive member AP has excellent or suitable adhesive strength (and peel adhesion), and may thus bond the display module DM and the window WP without lifting at the step SP-a portion.

The adhesive member AP may have a thickness TO of about 10 micrometers (μm) to about 500 μm, about 10 μm to about 300 μm, or about 10 μm to about 100 μm. However, this is presented as an example, and the thickness TO of the adhesive member AP is not limited thereto.

The adhesive member AP may have a 180° peel strength of about 800 gf/25 mm or greater for at least one of a glass substrate or a polymer substrate at about 25 °C. The polymer substrate may be polyethylene terephthalate (PET), but embodiments of the present disclosure are not limited thereto. In addition, the adhesive member AP may have a 180° peel strength of about 200 gf/25 mm or greater for at least one of a glass substrate or a polymer substrate at a temperature of about 60 °C. The adhesive member AP may have a 180° peel strength of about 100 gf/25 mm or greater for at least one of a glass substrate or a polymer substrate at a temperature of about 85 °C and a relative humidity of about 85%. Therefore, the adhesive member AP according to one or more embodiments may exhibit excellent or suitable adhesion at room temperature and also at high-temperature and high-humidity environments.

The adhesive member AP may be formed from the resin composition according to one or more embodiments. The resin composition according to one or more embodiments may include a (meth)acrylate copolymer, a monofunctional (meth)acrylate monomer, a photoradical polymerization initiator, and a photocationic polymerization initiator. Herein, the (meth)acrylate indicates both acrylate and methacrylate. For example, the (meth)acrylate may include acrylate and/or methacrylate.

The resin composition according to one or more embodiments includes a (meth)acrylate copolymer, and may thus prevent or reduce the inhibition of surface curing of the resin composition exposed to the air, thereby exhibiting excellent or suitable adhesion (and adherence), unlike typical resin compositions where curing failure occurs due to oxygen during photocuring in the air atmosphere.

The (meth)acrylate copolymer according to one or more embodiments may be a copolymer of (e.g., polymerized by including) a cationically reactive (meth)acrylate monomer and a non-cationically reactive (meth)acrylate monomer. In other words, the (meth)acrylate copolymer according to one or more embodiments may be a product of copolymerizing a cationically reactive (meth)acrylate monomer and a non-cationically reactive (meth)acrylate monomer. The cationically reactive (meth)acrylate monomer may include a cationically polymerizable functional group. For example, the cationically reactive (meth)acrylate monomer may include an epoxy group or an oxetane group, both of which exhibit excellent or suitable cationic polymerizability. The (meth)acrylate copolymer may be a copolymer of (e.g., polymerized by including) a cationically reactive (meth)acrylate monomer containing an epoxy group and a non-cationically reactive (meth)acrylate monomer, or may be a copolymer (e.g., polymerized by including) a cationically reactive (meth)acrylate monomer containing an oxetane group and a non-cationically reactive (meth)acrylate monomer. Herein, the cationically reactive (meth)acrylate monomer containing an epoxy group may be referred to as a ‘first monomer’, and the cationically reactive (meth)acrylate monomer containing an oxetane group may be referred to as a ‘second monomer’. In addition, herein, the non-cationically reactive (meth)acrylate monomer may be referred to as a ‘third monomer’.

In one or more embodiments, the (meth)acrylate copolymer may be a copolymer of (e.g., polymerized by including) the first monomer and the third monomer. In one or more embodiments, the (meth)acrylate copolymer may be a copolymer of (e.g., polymerized by including) the second monomer and the third monomer. Herein, the (meth)acrylate copolymer obtained by copolymerizing the first monomer and the third monomer may be referred to as a ‘first copolymer’. The (meth)acrylate copolymer obtained by copolymerizing the second monomer and the third monomer may be referred to as a ‘second copolymer’. The (meth)acrylate copolymer may be the first copolymer or the second copolymer.

In one or more embodiments, the resin composition includes the first copolymer or the second copolymer, and may thus prevent or reduce the inhibition of surface curing during photocuring in the presence of oxygen. For example, a resin composition including the first copolymer or the second copolymer may improve cohesion at an interface where the (meth)acrylate copolymer (i.e., the first copolymer and/or the second copolymer) is in contact with the atmosphere by segregating toward an outermost surface during photocuring. In addition, the resin composition includes the first copolymer or the second copolymer, and may thus maintain excellent or suitable adhesion (and adherence) at room temperature and also at high-temperature and high-humidity environments through interaction with the resin matrix via a photocationic reaction involving an epoxy group or an oxetane group.

The first copolymer may be a copolymer of (e.g., polymerized by including) the first monomer in an amount less than that of the third monomer. In one or more embodiments, the first copolymer may be a copolymer of (e.g., polymerized by including) the first monomer in an amount of about 1 part to about 30 parts by mass with respect to 100 parts by mass of a total of the first monomer and the third monomer. When the resin composition includes the first copolymer polymerized by including the first monomer in the above content (e.g., amount) range, the adhesive member AP formed from such resin composition may exhibit excellent or suitable adhesion at room temperature, high-temperature, and high-temperature and high-humidity environments.

If (e.g., when) the resin composition includes a first copolymer polymerized by including the first monomer in an amount of less than about 1 part by mass, the resin composition may have reduced internal cohesion, and thus the adhesive member formed from the resin composition may have degraded adhesion at high-temperature and high-humidity environments. If (e.g., when) the resin composition includes a first copolymer polymerized by including the first monomer in an amount of more than about 30 parts by mass, the resin composition may have increased internal cohesion, but adhesiveness to a substrate such as a glass substrate may be reduced.

The content (e.g., amounts) of the second monomer and the third monomer used in the polymerization of the second copolymer are not particularly limited. However, in one or more embodiments, the second copolymer may be polymerized by including the second monomer in an amount less than that of the third monomer. In one or more embodiments, the second copolymer may be polymerized by including the second monomer in an amount of about 1 part to about 30 parts by mass with respect to 100 parts by mass of a total of the second monomer and the third monomer.

The first copolymer and the second copolymer may each have a weight average molecular weight (Mw) of about 3,000 to about 30,000. The weight average molecular weight may be indicated without a unit, but may be indicated in units of g/mol with respect to molar mass. The resin composition according to one or more embodiments includes the first copolymer or the second copolymer each having a weight average molecular weight of about 3,000 to about 30,000, and may thus prevent or reduce the inhibition of surface curing during photocuring and exhibit excellent or suitable adhesive/adherent properties at room temperature and also in high-temperature and high-humidity environments. In the disclosure, unless stated otherwise, the weight average molecular weight of a polymer, for example, the (meth)acrylate copolymer, is measured and characterized with gel permeation chromatograph (GPC) with polystyrene standards.

The first copolymer or the second copolymer may be included in an amount of about 5 parts to about 50 parts by mass with respect to 100 parts by mass of the monofunctional (meth)acrylate monomer in the resin composition. If (e.g., when) the first copolymer or the second copolymer is included in an amount of less than about 5 parts by mass, the amount of copolymer segregated onto a surface of the resin composition after curing is small, resulting in insufficient adhesive/adherent properties in terms of cohesion. If (e.g., when) the amount of the first copolymer or the second copolymer exceeds about 50 parts by mass, the amount of copolymer segregated onto a surface of the resin composition after curing is large, resulting in insufficient adhesive/adherent properties due to excessive cohesion. The resin composition according to one or more embodiments may exhibit excellent or suitable adhesion and adherence during photocuring if (e.g., when) the first copolymer or the second copolymer is included in the above content (e.g., amount) range.

The cationically reactive (meth)acrylate monomer may include at least one of glycidyl acrylate, glycidyl methacrylate, (3,4-epoxycyclohexyl)methyl acrylate, (3,4-epoxycyclohexyl)methyl methacrylate, (3-ethyloxetan-3-yl)methyl acrylate, or (3-ethyloxetan-3-yl)methyl methacrylate. For example, in one or more embodiments, the first monomer may include at least one of glycidyl acrylate, glycidyl methacrylate, (3,4-epoxycyclohexyl)methyl acrylate, or 3,4-epoxycyclohexyl methyl methacrylate. In one or more embodiments, the first monomer may be glycidyl methacrylate or 3,4-epoxycyclohexyl methyl methacrylate. In one or more embodiments, the second monomer may include at least one of (3-ethyloxetan-3-yl)methyl acrylate or (3-ethyloxetan-3-yl)methyl methacrylate. However, embodiments of the present disclosure are not limited thereto.

The third monomer may include at least one of methyl methacrylate or isobornyl methacrylate. In one or more embodiments, the third monomer may include both (e.g., simultaneously)methyl methacrylate and isobornyl methacrylate. However, embodiments of the present disclosure are not limited thereto, and the third monomer may include methyl methacrylate and/or isobornyl methacrylate, or may include other non-cationically reactive (meth)acrylate monomers.

The monofunctional (meth)acrylate monomer may include at least one of a hydroxyl group-containing monofunctional (meth)acrylate monomer, an alicyclic monofunctional (meth)acrylate monomer, or an alkyl monofunctional (meth)acrylate monomer. In one or more embodiments, the monofunctional (meth)acrylate monomer may include at least one of 4-hydroxybutylacrylate, 2-ethylhexylacrylate, or tetrahydrofurfuryl acrylate. For example, in one or more embodiments, the monofunctional (meth)acrylate monomer may include 4-hydroxybutylacrylate, 2-ethylhexylacrylate, and tetrahydrofurfuryl acrylate, but embodiments of the present disclosure are not limited thereto.

The monofunctional (meth)acrylate monomer may have a weight average molecular weight of about 500 or less, or a molecular weight of about 500 g/mol or less. For example, in one or more embodiments, the monofunctional (meth)acrylate monomer may have a weight average molecular weight of about 100 to about 500, or a molecular weight of about 100 g/mol to about 500 g/mol. The weight average molecular weight or the molecular weight of the monofunctional (meth)acrylate monomer may not be limited to the above range.

The resin composition according to one or more embodiments may include a photopolymerization initiator. The resin composition may include two or more different types (kinds) of photopolymerization initiators. For example, in one or more embodiments, the resin composition may include a photoradical polymerization initiator and a photocationic polymerization initiator. The photopolymerization initiator may be included in an amount of about 0.01 mass % to about 5 mass % with respect to a total mass of the resin composition, but the content (e.g., amount) of the photopolymerization initiator included in the resin composition is not limited thereto.

The photoradical polymerization initiator may be activated by ultraviolet light. For example, in one or more embodiments, the resin composition may include phenylbis(2,4,6-trimethylbenzoyl)phosphine oxide as the photoradical polymerization initiator, but embodiments of the present disclosure are not limited thereto.

The photocationic polymerization initiator may generate cations or Lewis acids by ultraviolet light and initiate the polymerization of a cationically curable component, such as a cationically reactive (meth)acrylate monomer containing an epoxy group or an oxetane group. In one or more embodiments, the photocationic polymerization initiator may include a borate and/or a sulfonate. For example, in one or more embodiments, the resin composition may include CPI-310B (manufactured by SAN-APRO) of [1,1′-biphenyl]-4-yl-[4-[[1,1′-biphenyl]-4-ylthio]phenyl] (phenyl)sulfoniumtetrakis(perfluorophenyl)borate (including a mixture of isomers) as the photocationic polymerization initiator, but embodiments of the present disclosure are not limited thereto.

For example, in one or more embodiments, the photopolymerization initiator may be at least one of 2,2-dimethoxy-1,2-diphenylethan-1-one, 1-hydroxy cyclohexyl-phenylketone, 2-hydroxy-2-methyl-1-phenyl-1-propanone, 2-hydroxy-1-[4-(2-hydroxyethoxy)phenyl]-2-methyl-1-propanone, or 2-hydroxy-1-{4-[4-(2-hydroxy-2-methyl-propionyl)-benzyl]-phenyl}-2-methylpropan-1-one.

In one or more embodiments, the photopolymerization initiator may be at least one of 2-methyl-1 [4-(methylthio)phenyl]-2-morpholinopropan-1-one, 2-benzyl-2-dimethylamino-1-(4-morpholinophenyl)-butanone-1,2-dimethylamino-2-(4-methyl-benzyl)-1-(4-morpholin-4-yl-phenyl)-butan-1-one, 2,4,6-trimethylbenzoyl-diphenylphosphine oxide, [1-(4-phenylsulfanylbenzoyl)heptylideneamino]benzoate, [1-[9-ethyl-6-(2-methylbenzoyl)carbazol-3-yl]ethylideneamino]acetate), or bis(2,4-cyclopentadienyl)bis[2,6-difluoro-3-(1-pyrryl)phenyl] titanium(IV).

The resin composition according to one or more embodiments may not include (e.g., may exclude) a cationically reactive compound as a component thereof. For example, the resin composition may not include (e.g., may exclude) any additional cationically reactive compound other than the cationically reactive (meth)acrylate of the first monomer and the second monomer included in the polymerization of the first copolymer and the second copolymer.

In addition, the resin composition according to one or more embodiments may not include (e.g., may exclude) a solvent. The resin composition may not include (e.g., may exclude) a volatile organic solvent. The resin composition according to one or more embodiments may be provided as solvent-free resin composition. The solvent-free resin composition may improve discharge easiness when provided via inkjet printing or dispensing. In addition, when using the solvent-free resin composition in a process for preparing an adhesive member AP, unlike a resin composition including a volatile organic solvent, processes such as a heating process for drying the volatile organic solvent may be skipped, thereby improving process efficiency.

In one or more embodiments, the resin composition may include only (e.g., consists of or consists essentially of) a (meth)acrylate copolymer of the first copolymer or the second copolymer, a monofunctional (meth)acrylate monomer, a photoradical polymerization initiator, and a photocationic polymerization initiator as components of the resin composition. For example, in one or more embodiments, the resin composition may be formed of a (meth)acrylate copolymer of the first copolymer or the second copolymer, a monofunctional (meth)acrylate monomer, a photoradical polymerization initiator, and a photocationic polymerization initiator.

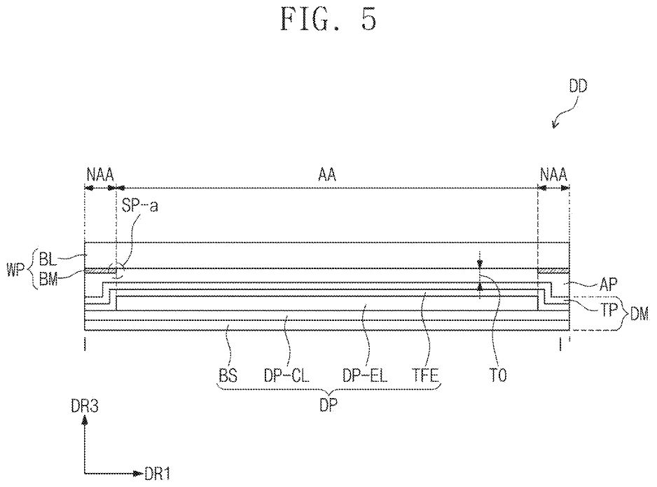

FIGS. 6A to 6C are views schematically showing some steps of a method for manufacturing an electronic device according to one or more embodiments of the present disclosure. FIGS. 6A to 6C may be views for describing steps of forming an adhesive member included in an electronic device according to one or more embodiments. To provide descriptions with reference to FIGS. 6A to 6C, descriptions that overlap the descriptions provided with reference to FIGS. 1 to 5 will not be provided again, and differences will be mainly described.

Referring to FIGS. 6A to 6C, a method for manufacturing an electronic device according to one or more embodiments may include providing a resin composition RC, forming an adhesive member AP, and bonding neighboring members BP1 and BP2 through the adhesive member AP. The adhesive member AP may be formed from the resin composition RC according to one or more embodiments of the present disclosure. The forming of the adhesive member AP may include a curing step of curing the resin composition.

Referring to FIG. 6A, the resin composition according to one or more embodiments may be provided on a first substrate BP1. The first substrate BP1 may provide a reference surface on which the resin composition RC is provided. For example, the first substrate BP1 may be the display module DM or the window WP described in FIG. 5. The resin composition RC may be directly applied onto one surface of the first substrate BP1.

In one or more embodiments, the first substrate BP1 may also be a temporary substrate used to form the adhesive member AP from the resin composition RC. If (e.g., when) the first substrate BP1 is provided as a temporary substrate, any substrate that allows for easy detachment of the cured resin composition RC provided on the first substrate BP1 after being cured may be used without limitation.

The resin composition RC according to one or more embodiments may be provided on the first substrate BP1 through an inkjet printing method, a dispensing method, or a bar coat method. For example, in one or more embodiments, the resin composition RC may be provided on the first substrate BP1 through an inkjet printing method. The resin composition RC may be discharged from an inkjet head IHD and provided on the first substrate BP1. The inkjet head IHD may include a plurality of nozzles NZ, which may be spaced and/or apart (e.g., spaced apart or separated) by a specified or set interval along one direction.

Each of the nozzles NZ may each discharge the resin composition RC toward the first substrate BP1. For example, a discharge direction of each of the nozzles NZ may be a direction perpendicular to the first substrate BP1. In one or more embodiments, each of the nozzles NZ may include a discharge port having a circular hole shape. However, embodiments of the present disclosure are not limited thereto, and a shape of the discharge port of each of the nozzles NZ may be variously or suitably altered. In addition, the number and size of the nozzles NZ included in the inkjet head IHD may be variously or suitably altered. Although the resin composition RC is shown to be provided through inkjet printing in FIG. 6A, the method of providing the resin composition RC is not limited thereto.

In one or more embodiments, the resin composition RC may be applied onto one surface of a base substrate in a flowable liquid state. For example, the resin composition RC is provided on one surface of the first substrate BP1, and the resin composition RC in a flowable liquid state may be provided up to an outer edge portion of the first substrate BP1. For example, the edge of the applied resin composition RC and the edge of the first substrate BP1 may be substantially parallel in a cross-section. Herein, the term ‘substantially’ includes embodiments in which physical values/characteristics are the same and embodiments in which there is a difference within a range of process error.

Referring to FIG. 6B, the resin composition RC applied onto the first substrate BP1 at a constant thickness may be irradiated with light UV. The resin composition RC may be cured by light. The light UV applied to the resin composition RC may be ultraviolet light. The adhesive member AP (FIG. 6C) may be formed from the cured resin composition RC.

The curing of the resin composition RC may be performed in an oxygen-containing atmosphere. The resin composition RC according to one or more embodiments does not require additional equipment and/or additional processes to block oxygen during UV irradiation, and may exhibit excellent or suitable adhesion without degradation of surface curing even if (e.g., when) irradiated with the light UV in the air atmosphere.

In one or more embodiments, the resin composition RC may be cured through a single step of photocuring. For example, the adhesive member AP according to one or more embodiments may be formed by providing the light UV to the resin composition RC once. The resin composition RC according to one or more embodiments may reduce an increase in the number of processes that cure by providing the light UV multiple times, thereby achieving effects such as cost reduction through process shortening.

While FIG. 6B shows direct irradiation of the resin composition RC with the light UV, embodiments of the present disclosure are not limited thereto. In one or more embodiments, a carrier film may be arranged on the resin composition RC applied to a substantially uniform thickness, and the carrier film may be to transmit ultraviolet light.

Referring to FIG. 6C, a second substrate BP2 may be bonded to the first substrate BP1 through the adhesive member AP. For example, by providing the second substrate BP2 on the adhesive member AP, which is a cured product of the resin composition RC (FIG. 6B), and applying a specified or set pressure, the second substrate BP2 may be attached to the first substrate BP1 through the adhesive member AP. For example, the adhesive member AP may laminate the first substrate BP1 and the second substrate BP2.

The second substrate BP2 may be the display module DM or the window WP described in FIG. 5. In one or more embodiments, the second substrate BP2 may be different from the first substrate BP1. For example, in one or more embodiments, if (e.g., when) the first substrate BP1 is the display module DM, the second substrate BP2 may be the window WP. In one or more embodiments, if (e.g., when) the first substrate BP1 is the window WP, the second substrate BP2 may be the display module DM.

The adhesive member AP, as a cured product of the resin composition RC, may exhibit excellent or suitable adhesions, with the 180° peel strength satisfying the above-described range even under conditions of room temperature of about 25 °C, high temperature of about 60 °C, and/or high temperature about 85 °C and relative humidity of about 85%. Accordingly, the display device DD (FIG. 5) including the adhesive member AP according to one or more embodiments may exhibit excellent or suitable durability.

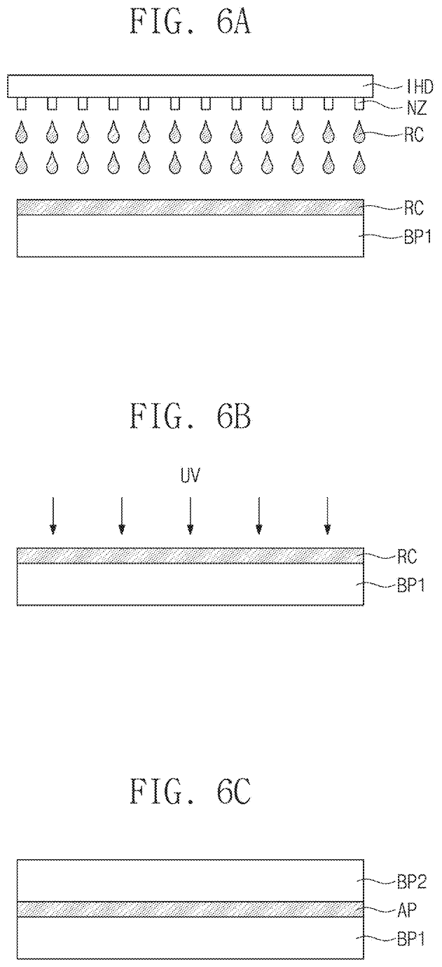

FIG. 7 is a cross-sectional view showing a display device DD-a according to one or more embodiments of the present disclosure. Hereinafter, to provide descriptions with respect to the display device DD-a shown in FIG. 7, descriptions that overlap the descriptions provided with reference to FIGS. 1 to 5 and 6A to 6C will not be provided again, and differences will be mainly described.

Compared with the display device DD described with reference to FIGS. 4 and 5, the display device DD-a shown in FIG. 7 may further include a light control layer PP and an optical adhesive layer AP-a. The display device DD-a according to one or more embodiments may further include a light control layer PP arranged between the adhesive member AP and the window WP, and an optical adhesive layer AP-a arranged between the light control layer PP and the window WP. The light control layer PP may include a polarizing plate or a color filter layer.

The optical adhesive layer AP-a may include a polymer derived from the resin composition RC (FIG. 6A) according to one or more embodiments. The optical adhesive layer AP-a may be formed from the resin composition RC according to one or more embodiments of the present disclosure. The optical adhesive layer AP-a formed from the resin composition RC according to one or more embodiments may have a 180° peel strength of about 800 gf/25 mm or greater for at least one of a glass substrate or a polymer substrate at a temperature of about 25 °C. The optical adhesive layer AP-a may have a 180° peel strength of about 200 gf/25 mm or greater for at least one of a glass substrate or a polymer substrate at a temperature of about 60 °C. The optical adhesive layer AP-a may have a 180° peel strength of about 100 gf/25 mm or greater for at least one of a glass substrate or a polymer substrate at a temperature of about 85 °C and a relative humidity of about 85%. Accordingly, the optical adhesive layer AP-a including a polymer derived from the resin composition RC according to one or more embodiments may exhibit excellent or suitable adhesion.

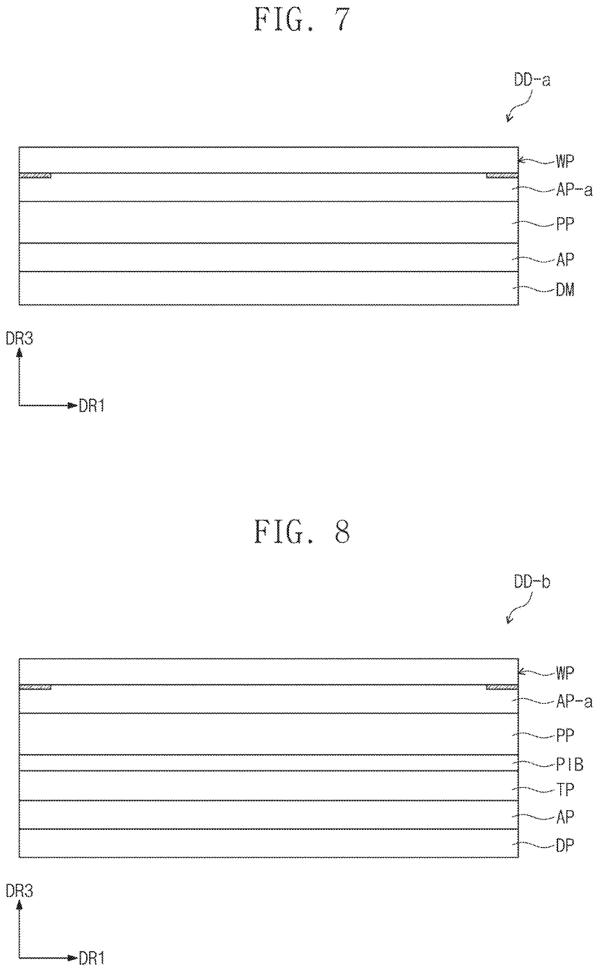

FIG. 8 is a cross-sectional view showing a display device DD-b according to one or more embodiments of the present disclosure. Hereinafter, to provide descriptions with respect to the display device DD-b according to one or more embodiments shown in FIG. 8, descriptions that overlap the descriptions provided with reference to FIGS. 1 to 7 will not be provided again, and differences will be mainly described.

Compared with the display device DD described with reference to FIGS. 4 and 5, the display device DD-b according to one or more embodiments shown in FIG. 8 may further include a light control layer PP, an optical adhesive layer AP-a, and an interlayer adhesive layer PIB. As the display device DD-a according to one or more embodiments shown in FIG. 7, the display device DD-b according to one or more embodiments shown in FIG. 8 may further include the light control layer PP arranged between the adhesive member AP and the window WP, and the optical adhesive layer AP-a arranged between the light control layer PP and the window WP.

In the display device DD-b according to one or more embodiments, the adhesive member AP may be provided between the display panel DP and the input sensing portion TP. For example, the input sensing portion TP may not be directly arranged on the display panel DP, and the display panel DP and the input sensing portion TP may be bonded through the adhesive member AP. For example, the adhesive member AP may be arranged between the encapsulation layer TFE (FIG. 5) of the display panel DP and the input sensing portion TP.

The interlayer adhesive layer PIB may be provided below the light control layer PP. The interlayer adhesive layer PIB may be arranged between the input sensing portion TP and the light control layer PP and may be formed of an adhesive material having excellent or suitable moisture permeation prevention properties. For example, in one or more embodiments, the interlayer adhesive layer PIB may be formed including polyisobutylene. The interlayer adhesive layer PIB may be arranged on the input sensing portion TP to prevent or reduce corrosion of sensing electrodes of the input sensing portion TP. The display device DD-b according to one or more embodiments includes the optical adhesive layer AP-a and the adhesive member AP each formed from the resin composition RC (FIG. 6A) according to one or more embodiments, and the display device DD-b including the optical adhesive layer AP-a and the adhesive member AP may exhibit excellent or suitable reliability.

Hereinafter, with reference to Examples and Comparative Examples, the resin composition according to one or more embodiments of the disclosure and the adhesive member formed from the resin composition will be specifically described. In addition, Examples provided herein are shown only for the understanding of the disclosure, and the scope of the disclosure is not limited thereto.

### EXAMPLES

### 1. Preparation of (meth)acrylate Copolymer

### (1) Synthesis Example 1: Synthesis of MC-1

To a round bottom flask equipped with a condenser, a dropping funnel, a nitrogen inlet tube, and a magnetic stirrer, 40 mL of butyl acetate was added, and the solution was stirred at room temperature for 30 minutes while bubbling nitrogen to deoxygenate the solvent. The resulting solution was heated in an oil bath up to an internal temperature of about 90 °C. To a separate dropping funnel, 14.0 g of methyl methacrylate (MMA, Tokyo Chemical Industry Co., Ltd.), 11.0 g of isobornyl methacrylate (IBXMA, Tokyo Chemical Industry Co., Ltd.), 10.0 g of glycidyl methacrylate (GMA, manufactured by Tokyo Kasei Kogyo Co., Ltd.), 0.5 g of V-601 (dimethyl 2,2′-azobis(2-methylpropionate) (Fujifilm Wako Pure Chemical Industries, Ltd.) as a thermal polymerization initiator, and 10 mL of butyl acetate were added to prepare a homogeneous mixture, and a cock of the dropping funnel was opened to slowly add the mixture dropwise into the flask over an hour. Thereafter, the resulting mixture was stirred for 3 hours to perform a polymerization reaction. After the polymerization reaction, the flask was removed from the oil bath and cooled sufficiently. Thereafter, 800 mL of ethanol was added to a 1,000 mL beaker and stirred with a magnetic stirrer, into which the solution from the flask after the polymerization reaction was then gradually added dropwise to extract a precipitate. The precipitate was filtered using suction filtration, and washed and filtered again with ethanol to remove butyl acetate and unreacted monomers. The precipitate was dried under reduced pressure to obtain 32.0 g of white powder MC-1 which is a copolymer of MMA, IBXMA, and GMA. The obtained white powder MC-1 had a weight average molecular weight of 25,000.

### (2) Synthesis Example 2: Synthesis of MC-2

32.6 g of white powder MC-2 which is a copolymer of MMA, IBXMA, and M100 (3,4-epoxycyclohexylmethyl methacrylate) was obtained in substantially the same synthesis method as in Synthesis Example 1, except that 10.0 g of cyclomer M100 (M100 from Daicel) was used instead of GMA. The obtained white powder MC-2 had a weight average molecular weight of 30,000.

### (3) Synthesis Example 3: Synthesis of MC-3

24.8 g of white powder MC-3 which is a copolymer of MMA, IBXMA, and OXE-30 ((3-ethyloxetane-3-yl)methyl methacrylate) was obtained in substantially the same synthesis method as in Synthesis Example 1, except that 10.0 g of OXE-30 (Osaka Organic Chemical Industry Co., Ltd.) was used instead of GMA. The obtained white powder MC-3 had a weight average molecular weight of 27,000.

### (4) Synthesis Example 4: Synthesis of MC-4

30.7 g of white powder MC-4 which is a copolymer of MMA, IBXMA, and GMA was obtained in substantially the same synthesis method as in Synthesis Example 1, except that the amount of V-601 was changed to 4.0 g. The obtained white powder MC-4 had a weight average molecular weight of 4,000.

### (5) Synthesis Example 5: Synthesis of MC-5

31.9 g of white powder MC-5 which is a copolymer of MMA, IBXMA, and M100 was obtained in substantially the same synthesis method as in Synthesis Example 2, except that the amount of V-601 was changed to 4.0 g. The obtained white powder MC-5 had a weight average molecular weight of 5,500.

### (6) Synthesis Example 6: Synthesis of MC-6

29.9 g of white powder MC-6 which is a copolymer of MMA, IBXMA, and OXE-30 was obtained in substantially the same synthesis method as in Synthesis Example 3, except that the amount of V-601 was changed to 4.0 g. The obtained white powder MC-6 had a weight average molecular weight of 4,800.

### (7) Synthesis Example 7: Synthesis of MC-7

24.8 g of white powder MC-7 which is a copolymer of MMA, IBXMA, and GMA was obtained in substantially the same synthesis method as in Synthesis Example 1, except that the amount of GMA was changed to 0.3 g. The obtained white powder MC-7 had a weight average molecular weight of 20,000.

### (8) Synthesis Example 8: Synthesis of MC-8

25.0 g of white powder MC-8 which is a copolymer of MMA, IBXMA, and M100 was obtained in substantially the same synthesis method as in Synthesis Example 2, except that the amount of M100 was changed to 0.3 g. The obtained white powder MC-8 had a weight average molecular weight of 22,000.

### (9) Synthesis Example 9: Synthesis of MC-9

24.8 g of white powder MC-9 which is a copolymer of MMA, IBXMA, and OXE-30 was obtained in substantially the same synthesis method as in Synthesis Example 3, except that the amount of OXE-30 was changed to 0.3 g. The obtained white powder MC-9 had a weight average molecular weight of 19,000.

### (10) Synthesis Example 10: Synthesis of MC-10

23.3 g of white powder MC-10 which is a copolymer of MMA, IBXMA, and GMA was obtained in substantially the same synthesis method as in Synthesis Example 7, except that the amount of V-601 was changed to 4.0 g. The obtained white powder MC-10 had a weight average molecular weight of 3,200.

### (11) Synthesis Example 11: Synthesis of MC-11

24.1 g of white powder MC-11 which is a copolymer of MMA, IBXMA, and M100 was obtained in substantially the same synthesis method as in Synthesis Example 8, except that the amount of V-601 was changed to 4.0 g. The obtained white powder MC-11 had a weight average molecular weight of 3,400.

### (12) Synthesis Example 12: Synthesis of MC-12

22.9 g of white powder MC-12 which is a copolymer of MMA, IBXMA, and OXE-30 was obtained in substantially the same synthesis method as in Synthesis Example 9, except that the amount of V-601 was changed to 4.0 g. The obtained white powder MC-12 had a weight average molecular weight of 3,100.

### (13) Synthesis Example 13: Synthesis of MC-13

23.3 g of white powder MC-13 which is a copolymer of MMA and IBXMA was obtained in substantially the same synthesis method as in Synthesis Example 1, except that GMA was not added. The obtained white powder MC-13 had a weight average molecular weight of 21,000.

### (14) Synthesis Example 14: Synthesis of MC-14

22.3 g of white powder MC-14 which is a copolymer of MMA and IBXMA was obtained in substantially the same synthesis method as in Synthesis Example 4, except that GMA was not added. The obtained white powder MC-14 had a weight average molecular weight of 3,100.

### (15) Synthesis Example 15: Synthesis of MC-15

31.8 g of white powder MC-15 which is a copolymer of MMA, IBXMA, and GMA was obtained in substantially the same synthesis method as in Synthesis Example 1, except that the amount of GMA was changed to 12.0 g, and the amount of V-601 was changed to 0.6 g. The obtained white powder MC-15 had a weight average molecular weight of 25,000.

### (16) Synthesis Example 16: Synthesis of MC-16

34.0 g of white powder MC-16 which is a copolymer of MMA, IBXMA, and M100 was obtained in substantially the same synthesis method as in Synthesis Example 2, except that the amount of M100 was changed to 12.0 g, and the amount of V-601 was changed to 0.6 g. The obtained white powder MC-16 had a weight average molecular weight of 29,000.

### (17) Synthesis Example 17: Synthesis of MC-17

31.3 g of white powder MC-17 which is a copolymer of MMA, IBXMA, and GMA was obtained in substantially the same synthesis method as in Synthesis Example 15, except that the amount of V-601 was changed to 5.0 g. The obtained white powder MC-17 had a weight average molecular weight of 3,800.

### (18) Synthesis Example 18: Synthesis of MC-18

32.6 g of white powder MC-18 which is a copolymer of MMA, IBXMA, and M100 was obtained in substantially the same synthesis method as in Synthesis Example 16, except that the amount of V-601 was changed to 5.0 g. The obtained white powder MC-18 had a weight average molecular weight of 5,500.

### (19) Synthesis Example 19: Synthesis of MC-19

24.1 g of white powder MC-19 which is a copolymer of MMA, IBXMA, and GMA was obtained in substantially the same synthesis method as in Synthesis Example 7, except that the amount of GMA was changed to 0.2 g. The obtained white powder MC-19 had a weight average molecular weight of 19,000.

### (20) Synthesis Example 20: Synthesis of MC-20

24.6 g of white powder MC-20 which is a copolymer of MMA, IBXMA, and M100 was obtained in substantially the same synthesis method as in Synthesis Example 8, except that the amount of M100 was changed to 0.2 g. The obtained white powder MC-20 had a weight average molecular weight of 21,000.

### (21) Synthesis Example 21: Synthesis of MC-21

22.9 g of white powder MC-21 which is a copolymer of MMA, IBXMA, and GMA was obtained in substantially the same synthesis method as in Synthesis Example 19, except that the amount of V-601 was changed to 3.5 g. The obtained white powder MC-21 had a weight average molecular weight of 3,100.

### (22) Synthesis Example 22: Synthesis of MC-22

23.8 g of white powder MC-22 which is a copolymer of MMA, IBXMA, and M100 was obtained in substantially the same synthesis method as in Synthesis Example 20, except that the amount of V-601 was changed to 3.5 g. The obtained white powder MC-22 had a weight average molecular weight of 3,200.

The mass (unit: g) of the cationically reactive (meth)acrylate monomer, the non-cationically reactive (meth)acrylate monomer, and the radical initiator used in Synthesis Examples 1 to 22 is shown in Tables 1 to 5. In addition, the weight average molecular weight of copolymers MC-1 to MC-22 synthesized from Synthesis Examples 1 to 22 is shown in Tables 1 to 5.

TABLE 1

| | | | Synthesis | Synthesis | Synthesis | Synthesis | Synthesis | Synthesis |
|---|---|---|---|---|---|---|---|---|
| | | | Example 1 | Example 2 | Example 3 | Example 4 | Example 5 | Example 6 |
| (Meth)acrylate | Cationically | GMA | 10 | | | 10 | | |
| monomer | reactive | M100 | | 10 | | | 10 | |
| | (meth)acrylate | OXE- | | | 10 | | | 10 |
| | monomer (m₁) | 30 | | | | | | |
| | Non- | MMA | 14 | 14 | 14 | 14 | 14 | 14 |
| | cationically | IBXMA | 11 | 11 | 11 | 11 | 11 | 11 |
| | reactive | | | | | | | |
| | (meth)acrylate | | | | | | | |
| | monomer (m₂) | | | | | | | |

| Radical initiator | V- | 0.5 | 0.5 | 0.5 | 4 | 4 | 4 |
|---|---|---|---|---|---|---|---|
| | 601 | | | | | | |

| | | | | | | |
|---|---|---|---|---|---|---|
| Weight average molecular | 25,000 | 30,000 | 27,000 | 4,000 | 5,500 | 4,800 |
| weight (Mw) of (meth)acrylate | | | | | | |
| copolymer | | | | | | |

TABLE 2

| | | | Synthesis | Synthesis | Synthesis | Synthesis | Synthesis | Synthesis |
|---|---|---|---|---|---|---|---|---|
| | | | Example 7 | Example 8 | Example 9 | Example 10 | Example 11 | Example 12 |
| (Meth)acrylate | Cationically | GMA | 0.3 | | | 0.3 | | |
| monomer | reactive | M100 | | 0.3 | | | 0.3 | |
| | (meth)acrylate | OXE- | | | 0.3 | | | 0.3 |
| | monomer (m₁) | 30 | | | | | | |
| | Non- | MMA | 14 | 14 | 14 | 14 | 14 | 14 |
| | cationically | IBXMA | 11 | 11 | 11 | 11 | 11 | 11 |
| | reactive | | | | | | | |
| | (meth)acrylate | | | | | | | |
| | monomer (m₂) | | | | | | | |

| Radical initiator | V- | 0.5 | 0.5 | 0.5 | 4 | 4 | 4 |
|---|---|---|---|---|---|---|---|
| | 601 | | | | | | |

| | | | | | | |
|---|---|---|---|---|---|---|
| Weight average molecular | 20,000 | 22,000 | 19,000 | 3,200 | 3,400 | 3,100 |
| weight (Mw) of (meth)acrylate | | | | | | |
| copolymer | | | | | | |

TABLE 3

| | | | Synthesis | Synthesis |
|---|---|---|---|---|
| | | | Example 13 | Example 14 |
| (Meth)acrylate | Cationically | GMA | | |
| monomer | reactive | M100 | | |
| | (meth)acrylate | OXE-30 | | |
| | monomer (m₁) | | | |
| | Non-cationically | MMA | 14 | 14 |
| | reactive | IBXMA | 11 | 11 |
| | (meth)acrylate | | | |
| | monomer (m₂) | | | |

| | | | |
|---|---|---|---|
| Radical initiator | V-601 | 0.5 | 4 |

| | | |
|---|---|---|
| Weight average molecular weight (Mw) of | 21,000 | 3,100 |
| (meth)acrylate copolymer | | |

TABLE 4

| | | | Synthesis | Synthesis | Synthesis | Synthesis | Synthesis | Synthesis |
|---|---|---|---|---|---|---|---|---|
| | | | Example 15 | Example 16 | Example 17 | Example 18 | Example 19 | Example 20 |
| (Meth)acrylate | Cationically | GMA | 12 | | 12 | | 0.2 | |
| monomer | reactive | M100 | | 12 | | 12 | | 0.2 |
| | (meth)acrylate | OXE- | | | | | | |
| | monomer (m₁) | 30 | | | | | | |
| | Non- | MMA | 14 | 14 | 14 | 14 | 14 | 14 |
| | cationically | IBXMA | 11 | 11 | 11 | 11 | 11 | 11 |
| | reactive | | | | | | | |
| | (meth)acrylate | | | | | | | |
| | monomer (m₂) | | | | | | | |

| Radical initiator | V- | 0.6 | 0.6 | 5 | 5 | 0.5 | 0.5 |
|---|---|---|---|---|---|---|---|
| | 601 | | | | | | |

| | | | | | | |
|---|---|---|---|---|---|---|
| Weight average molecular | 25,000 | 29,000 | 3,800 | 5,500 | 19,000 | 21,000 |
| weight (Mw) of (meth)acrylate | | | | | | |
| copolymer | | | | | | |

TABLE 5

| | | | Synthesis | Synthesis |
|---|---|---|---|---|
| | | | Example 21 | Example 22 |
| (Meth)acrylate | Cationically | GMA | 0.2 | |
| Monomer | reactive | M100 | | 0.2 |
| | (meth)acrylate | OXE-30 | | |
| | monomer (m₁) | | | |
| | Non-cationically | MMA | 14 | 14 |
| | reactive | IBXMA | 11 | 11 |
| | (meth)acrylate | | | |
| | monomer (m₂) | | | |

| | | | |
|---|---|---|---|
| Radical initiator | V-601 | 3.5 | 3.5 |

| | | |
|---|---|---|
| Weight average molecular weight (Mw) of | 3,100 | 3,200 |
| (meth)acrylate copolymer | | |

### 2. Preparation of Resin Composition

Tables 6 to 11 show the compositional components and contents (e.g., amounts) for each of the resin compositions of Examples and the resin compositions of Comparative Examples. Each component was added in a light-shielding, sealed container according to mixing ratios (e.g., by mass part) listed in Tables 6 to 11 and the mixture was stirred at room temperature for 12 hours using a mixing roller to prepare each of the resin compositions of Examples and each of the resin compositions of Comparative Examples.

TABLE 6

| Component | | Name | Example 1 | Example 2 | Example 3 | Example 4 | Example 5 | Example 6 | Example 7 |
|---|---|---|---|---|---|---|---|---|---|
| (A) | (Meth)acrylate | MC-1 | 5 | | | | | | |
| | copolymer | MC-2 | | 5 | | | | | |
| | | MC-3 | | | 5 | | | | |
| | | MC-4 | | | | 5 | | | |
| | | MC-5 | | | | | 5 | | |
| | | MC-6 | | | | | | 5 | |
| | | MC-7 | | | | | | | 5 |
| | | MC-8 | | | | | | | |
| | | MC-9 | | | | | | | |
| | | MC-10 | | | | | | | |
| | | MC-11 | | | | | | | |
| | | MC-12 | | | | | | | |
| | | MC-13 | | | | | | | |
| | | MC-14 | | | | | | | |
| | | MC-15 | | | | | | | |
| | | MC-16 | | | | | | | |
| | | MC-17 | | | | | | | |
| | | MC-18 | | | | | | | |
| | | MC-19 | | | | | | | |
| | | MC-20 | | | | | | | |
| | | MC-21 | | | | | | | |
| | | MC-22 | | | | | | | |
| (B) | Monofunctional | 4HBA | 5 | 5 | 5 | 5 | 5 | 5 | 5 |
| | (meth)acrylate | THFA | 20 | 20 | 20 | 20 | 20 | 20 | 20 |
| | monomer | 2EHA | 75 | 75 | 75 | 75 | 75 | 75 | 75 |
| (C) | Photoradical | Omnirad | 2 | 2 | 2 | 2 | 2 | 2 | 2 |
| | polymerization | 819 | | | | | | | |
| | initiator | | | | | | | | |
| (D) | Photocationic | CPI- | 3 | 3 | 3 | 3 | 3 | 3 | 3 |
| | polymerization | 310B | | | | | | | |
| | initiator | | | | | | | | |

TABLE 7

| Component | | Name | Example 8 | Example 9 | Example 10 | Example 11 | Example 12 | Example 13 | Example 14 |
|---|---|---|---|---|---|---|---|---|---|
| (A) | (Meth)acrylate | MC-1 | | | | | | 50 | |
| | copolymer | MC-2 | | | | | | | 50 |
| | | MC-3 | | | | | | | |
| | | MC-4 | | | | | | | |
| | | MC-5 | | | | | | | |
| | | MC-6 | | | | | | | |
| | | MC-7 | | | | | | | |
| | | MC-8 | 5 | | | | | | |
| | | MC-9 | | 5 | | | | | |
| | | MC-10 | | | 5 | | | | |
| | | MC-11 | | | | 5 | | | |
| | | MC-12 | | | | | 5 | | |
| | | MC-13 | | | | | | | |
| | | MC-14 | | | | | | | |
| | | MC-15 | | | | | | | |
| | | MC-16 | | | | | | | |
| | | MC-17 | | | | | | | |
| | | MC-18 | | | | | | | |
| | | MC-19 | | | | | | | |
| | | MC-20 | | | | | | | |
| | | MC-21 | | | | | | | |
| | | MC-22 | | | | | | | |
| (B) | Monofunctional | 4HBA | 5 | 5 | 5 | 5 | 5 | 5 | 5 |
| | (meth)acrylate | THFA | 20 | 20 | 20 | 20 | 20 | 20 | 20 |
| | monomer | 2EHA | 75 | 75 | 75 | 75 | 75 | 75 | 75 |
| (C) | Photoradical | Omnirad | 2 | 2 | 2 | 2 | 2 | 2 | 2 |
| | polymerization | 819 | | | | | | | |
| | initiator | | | | | | | | |
| (D) | Photocationic | CPI- | 3 | 3 | 3 | 3 | 3 | 3 | 3 |
| | polymerization | 310B | | | | | | | |
| | initiator | | | | | | | | |

TABLE 8

| Component | | Name | Example 15 | Example 16 | Example 17 | Example 18 | Example 19 | Example 20 | Example 21 |
|---|---|---|---|---|---|---|---|---|---|
| (A) | (Meth)acrylate | MC-1 | | | | | | | |
| | copolymer | MC-2 | | | | | | | |
| | | MC-3 | 50 | | | | | | |
| | | MC-4 | | 50 | | | | | |
| | | MC-5 | | | 50 | | | | |
| | | MC-6 | | | | 50 | | | |
| | | MC-7 | | | | | 50 | | |
| | | MC-8 | | | | | | 50 | |
| | | MC-9 | | | | | | | 50 |
| | | MC-10 | | | | | | | |
| | | MC-11 | | | | | | | |
| | | MC-12 | | | | | | | |
| | | MC-13 | | | | | | | |
| | | MC-14 | | | | | | | |
| | | MC-15 | | | | | | | |
| | | MC-16 | | | | | | | |
| | | MC-17 | | | | | | | |
| | | MC-18 | | | | | | | |
| | | MC-19 | | | | | | | |
| | | MC-20 | | | | | | | |
| | | MC-21 | | | | | | | |
| | | MC-22 | | | | | | | |
| (B) | Monofunctional | 4HBA | 5 | 5 | 5 | 5 | 5 | 5 | 5 |
| | (meth)acrylate | THFA | 20 | 20 | 20 | 20 | 20 | 20 | 20 |
| | monomer | 2EHA | 75 | 75 | 75 | 75 | 75 | 75 | 75 |
| (C) | Photoradical | Omnirad | 2 | 2 | 2 | 2 | 2 | 2 | 2 |
| | polymerization | 819 | | | | | | | |
| | initiator | | | | | | | | |
| (D) | Photocationic | CPI- | 3 | 3 | 3 | 3 | 3 | 3 | 3 |
| | polymerization | 310B | | | | | | | |
| | initiator | | | | | | | | |

TABLE 9

| | | | | | | Comparative | Comparative | Comparative | Comparative |
|---|---|---|---|---|---|---|---|---|---|
| Component | | Name | Example 22 | Example 23 | Example 24 | Example 1 | Example 2 | Example 3 | Example 4 |
| (A) | (Meth)acrylate | MC-1 | | | | | | | |
| | copolymer | MC-2 | | | | | | | |
| | | MC-3 | | | | | | | |
| | | MC-4 | | | | | | | |
| | | MC-5 | | | | | | | |
| | | MC-6 | | | | | | | |
| | | MC-7 | | | | | | | |
| | | MC-8 | | | | | | | |
| | | MC-9 | | | | | | | |
| | | MC-10 | 50 | | | | | | |
| | | MC-11 | | 50 | | | | | |
| | | MC-12 | | | 50 | | | | |
| | | MC-13 | | | | | 5 | 50 | |
| | | MC-14 | | | | | | | 5 |
| | | MC-15 | | | | | | | |
| | | MC-16 | | | | | | | |
| | | MC-17 | | | | | | | |
| | | MC-18 | | | | | | | |
| | | MC-19 | | | | | | | |
| | | MC-20 | | | | | | | |
| | | MC-21 | | | | | | | |
| | | MC-22 | | | | | | | |
| (B) | Monofunctional | 4HBA | 5 | 5 | 5 | 5 | 5 | 5 | 5 |
| | (meth)acrylate | THFA | 20 | 20 | 20 | 20 | 20 | 20 | 20 |
| | monomer | 2EHA | 75 | 75 | 75 | 75 | 75 | 75 | 75 |
| (C) | Photoradical | Omnirad | 2 | 2 | 2 | 2 | 2 | 2 | 2 |
| | polymerization | 819 | | | | | | | |
| | initiator | | | | | | | | |
| (D) | Photocationic | CPI- | 3 | 3 | 3 | | 3 | 3 | 3 |
| | polymerization | 310B | | | | | | | |
| | initiator | | | | | | | | |

TABLE 10

| | | | Comparative | Comparative | Comparative | Comparative | Comparative | Comparative |
|---|---|---|---|---|---|---|---|---|
| Component | | Name | Example 5 | Example 6 | Example 7 | Example 8 | Example 9 | Example 10 |
| (A) | (Meth)acrylate | MC-1 | | | | | | |
| | copolymer | MC-2 | | | | | | |
| | | MC-3 | | | | | | |
| | | MC-4 | | | | | | |
| | | MC-5 | | | | | | |
| | | MC-6 | | | | | | |
| | | MC-7 | | | | | | |
| | | MC-8 | | | | | | |
| | | MC-9 | | | | | | |
| | | MC-10 | | | | | | |
| | | MC-11 | | | | | | |
| | | MC-12 | | | | | | |
| | | MC-13 | | | | | | |
| | | MC-14 | 50 | | | | | |
| | | MC-15 | | 5 | | | | |
| | | MC-16 | | | 5 | | | |
| | | MC-17 | | | | 5 | | |
| | | MC-18 | | | | | 5 | |
| | | MC-19 | | | | | | 50 |
| | | MC-20 | | | | | | |
| | | MC-21 | | | | | | |
| | | MC-22 | | | | | | |
| (B) | Monofunctional | 4HBA | 5 | 5 | 5 | 5 | 5 | 5 |
| | (meth)acrylate | THFA | 20 | 20 | 20 | 20 | 20 | 20 |
| | monomer | 2EHA | 75 | 75 | 75 | 75 | 75 | 75 |
| (C) | Photoradical | Omnirad | 2 | 2 | 2 | 2 | 2 | 2 |
| | polymerization | 819 | | | | | | |
| | initiator | | | | | | | |
| (D) | Photocationic | CPI- | 3 | 3 | 3 | 3 | 3 | 3 |
| | polymerization | 310B | | | | | | |
| | initiator | | | | | | | |

TABLE 11

| | | | Compar- | Compar- | Compar- |
|---|---|---|---|---|---|
| | | | ative | ative | ative |
| | | | Exam- | Exam- | Exam- |
| Component | | Name | ple 11 | ple 12 | ple 13 |
| (A) | (Meth)acrylate | MC-1 | | | |
| | copolymer | MC-2 | | | |
| | | MC-3 | | | |
| | | MC-4 | | | |
| | | MC-5 | | | |
| | | MC-6 | | | |
| | | MC-7 | | | |
| | | MC-8 | | | |
| | | MC-9 | | | |
| | | MC-10 | | | |
| | | MC-11 | | | |
| | | MC-12 | | | |
| | | MC-13 | | | |
| | | MC-14 | | | |
| | | MC-15 | | | |
| | | MC-16 | | | |
| | | MC-17 | | | |
| | | MC-18 | | | |
| | | MC-19 | | | |
| | | MC-20 | 50 | | |
| | | MC-21 | | 50 | |
| | | MC-22 | | | 50 |
| (B) | Monofunctional | 4HBA | 5 | 5 | 5 |
| | (meth)acrylate | THFA | 20 | 20 | 20 |
| | monomer | 2EHA | 75 | 75 | 75 |
| (C) | Photoradical | Omnirad 819 | 2 | 2 | 2 |
| | polymerization | | | | |
| | initiator | | | | |
| (D) | Photocationic | CPI-310B | 3 | 3 | 3 |
| | polymerization | | | | |
| | initiator | | | | |

In Tables 6 to 11, components of the resin composition are as follows.

### (Meth)acrylate Copolymer

MC-1: Copolymer of MMA, IBXMA, and GMA synthesized through Synthesis Example 1
MC-2: Copolymer of MMA, IBXMA, and M100 synthesized through Synthesis Example 2
MC-3: Copolymer of MMA, IBXMA, and OXE-30 synthesized through Synthesis Example 3
MC-4: Copolymer of MMA, IBXMA, and GMA synthesized through Synthesis Example 4
MC-5: Copolymer of MMA, IBXMA, and M100 synthesized through Synthesis Example 5
MC-6: Copolymer of MMA, IBXMA, and OXE-30 synthesized through Synthesis Example 6
MC-7: Copolymer of MMA, IBXMA, and GMA synthesized through Synthesis Example 7
MC-8: Copolymer of MMA, IBXMA, and M100 synthesized through Synthesis Example 8
MC-9: Copolymer of MMA, IBXMA, and OXE-30 synthesized through Synthesis Example 9
MC-10: Copolymer of MMA, IBXMA, and GMA synthesized through Synthesis Example 10
MC-11: Copolymer of MMA, IBXMA, and M100 synthesized through Synthesis Example 11
MC-12: Copolymer of MMA, IBXMA, and OXE-30 synthesized through Synthesis Example 12
MC-13: Copolymer of MMA and IBXMA synthesized through Synthesis Example 13
MC-14: Copolymer of MMA and IBXMA synthesized through Synthesis Example 14
MC-15: Copolymer of MMA, IBXMA, and GMA synthesized through Synthesis Example 15
MC-16: Copolymer of MMA, IBXMA, and M100 synthesized through Synthesis Example 16
MC-17: Copolymer of MMA, IBXMA, and GMA synthesized through Synthesis Example 17
MC-18: Copolymer of MMA, IBXMA, and M100 synthesized through Synthesis Example 18
MC-19: Copolymer of MMA, IBXMA, and GMA synthesized through Synthesis Example 19
MC-20: Copolymer of MMA, IBXMA, and M100 synthesized through Synthesis Example 20
MC-21: Copolymer of MMA, IBXMA, and GMA synthesized through Synthesis Example 21
MC-22: Copolymer of MMA, IBXMA, and M100 synthesized through Synthesis Example 20

### Monofunctional (meth)acrylate Monomer

4HBA: 4-hydroxybutyl acrylate (manufactured by Osaka Organic Chemical Industry Co., Ltd.)
THFA: tetrahydrofurfuryl acrylate
2EHA: 2-ethylhexyl acrylate (manufactured by Toagosei Co., Ltd.)

### Photoradical Polymerization Initiator

Omnirad 819: Phenylbis(2,4,6-trimethylbenzoyl)phosphine oxide (manufactured by IGM Resins)

### Photocationic Polymerization Initiator

CPI-310B: [1,1′-biphenyl]-4-yl[4-[[1,1′-biphenyl]-4-ylthio]phenyl](phenyl)sulfoniumtetrakis(perfluorophenyl)borate (including mixture of isomers, manufactured by SAN-APRO)

### 3. Evaluation of Properties of Resin Composition

### 1) Evaluation of Adhesive Properties

Each of resin compositions of Examples or Comparative Examples was applied onto one surface of a 76×26 mm slide glass substrate to a thickness of 100 μm and cured through irradiation with ultraviolet light in an air atmosphere to prepare a corresponding adhesive member. Thereafter, a 150 mm×20 mm, 50 μm thick PET film substrate was laminated using an atmospheric pressure laminator to form a laminate, and then the laminate was subjected to vacuum degassing in an autoclave at 30 °C/0.5 MPa for 5 minutes. The obtained laminate was used as a peel test specimen.

A 180° peel test was performed under conditions of 25 °C, 60 °C, and 85 °C/85% RH in accordance with JIS Z0237. An average of peel strength in the range of 20 mm to 80 mm from the initiation of peeling was used as an evaluation value, and the evaluation value at each temperature was evaluated according to the following 3-grade criteria, and the results are listed in Tables 9 to 13. For the peel strength, ⊚ and ∘ were set as passing (with ⊚ signifying particularly excellent results), and × was set as failing.

### Evaluation Criteria for Peel Strength at 25 °C.

⊚: Peel strength of 1500 (gf/25 mm) or greater
∘: Peel strength of 800 (gf/25 mm) or greater but less than 1500 (gf/25 mm)
×: Peel strength of less than 800 (gf/25 mm)

### Evaluation Criteria for Peel Strength at 60 °C:

⊚: Peel strength of 500 (gf/25 mm) or greater
∘: Peel strength of 200 (gf/25 mm) or greater but less than 500 (gf/25 mm)
×: Peel strength of less than 200 (gf/25 mm)

### Evaluation Criteria for Peel Strength at 85 °C/85% RH:

⊚: Peel strength of 200 (gf/25 mm) or greater
∘: Peel strength of 100 (gf/25 mm) or greater but less than 200 (gf/25 mm)
×: Peel strength of less than 100 (gf/25 mm)

TABLE 12

| Item | Example 1 | Example 2 | Example 3 | Example 4 | Example 5 | Example 6 | Example 7 |
|---|---|---|---|---|---|---|---|
| Peel strength | ⊚ | ⊚ | ⊚ | ⊚ | ⊚ | ⊚ | ◯ |
| [gf/25 mm] at | | | | | | | |
| 25 °C | | | | | | | |
| Peel strength | ◯ | ⊚ | ⊚ | ◯ | ◯ | ◯ | ◯ |
| [gf/25 mm] at | | | | | | | |
| 60 °C | | | | | | | |
| Peel strength | ◯ | ◯ | ◯ | ◯ | ◯ | ◯ | ◯ |
| [gf/25 mm] at | | | | | | | |
| 85 °C/85% RH | | | | | | | |

TABLE 13

| Item | Example 8 | Example 9 | Example 10 | Example 11 | Example 12 | Example 13 | Example 14 |
|---|---|---|---|---|---|---|---|
| Peel strength | ◯ | ◯ | ◯ | ◯ | ◯ | ⊚ | ⊚ |
| [gf/25 mm] at | | | | | | | |
| 25 °C | | | | | | | |
| Peel strength | ◯ | ◯ | ◯ | ◯ | ◯ | ⊚ | ⊚ |
| [gf/25 mm] at | | | | | | | |
| 60 °C | | | | | | | |
| Peel strength | ◯ | ◯ | ◯ | ◯ | ◯ | ◯ | ⊚ |
| [gf/25 mm] at | | | | | | | |
| 85 °C/85% RH | | | | | | | |

TABLE 14

| Item | Example 15 | Example 16 | Example 17 | Example 18 | Example 19 | Example 20 | Example 21 |
|---|---|---|---|---|---|---|---|
| Peel strength | ⊚ | ⊚ | ⊚ | ⊚ | ⊚ | ⊚ | ⊚ |
| [gf/25 mm] at | | | | | | | |
| 25 °C | | | | | | | |
| Peel strength | ⊚ | ⊚ | ⊚ | ⊚ | ⊚ | ⊚ | ⊚ |
| [gf/25 mm] at | | | | | | | |
| 60 °C | | | | | | | |
| Peel strength | ⊚ | ◯ | ◯ | ⊚ | ◯ | ◯ | ◯ |
| [gf/25 mm] at | | | | | | | |
| 85 °C/85% RH | | | | | | | |

TABLE 15

| | | | | Comparative | Comparative | Comparative | Comparative |
|---|---|---|---|---|---|---|---|
| Item | Example 22 | Example 23 | Example 24 | Example 1 | Example 2 | Example 3 | Example 4 |
| Peel | ⊚ | ⊚ | ⊚ | X | ⊚ | ⊚ | ◯ |
| strength | | | | | | | |
| [gf/25 | | | | | | | |
| mm] at | | | | | | | |
| 25 °C | | | | | | | |
| Peel | ◯ | ◯ | ◯ | X | X | X | X |
| strength | | | | | | | |
| [gf/25 | | | | | | | |
| mm] at | | | | | | | |
| 60 °C | | | | | | | |
| Peel | ◯ | ◯ | ◯ | X | X | X | X |
| strength | | | | | | | |
| [gf/25 | | | | | | | |
| mm] at | | | | | | | |
| 85 °C/ | | | | | | | |
| 85% RH | | | | | | | |

TABLE 16

| | Comparative | Comparative | Comparative | Comparative | Comparative | Comparative | Comparative |
|---|---|---|---|---|---|---|---|
| Item | Example 5 | Example 6 | Example 7 | Example 8 | Example 9 | Example 10 | Example 11 |
| Peel | ⊚ | X | X | X | X | ◯ | ◯ |
| strength | | | | | | | |
| [gf/25 | | | | | | | |
| mm] at | | | | | | | |
| 25 °C | | | | | | | |
| Peel | X | ◯ | ◯ | ⊚ | ⊚ | X | X |
| strength | | | | | | | |
| [gf/25 | | | | | | | |
| mm] at | | | | | | | |
| 60 °C | | | | | | | |
| Peel | X | ◯ | ◯ | ⊚ | ⊚ | X | X |
| strength | | | | | | | |
| [gf/25 | | | | | | | |
| mm] at | | | | | | | |
| 85 °C/ | | | | | | | |
| 85% RH | | | | | | | |

TABLE 17

| | Comparative | Comparative |
|---|---|---|
| Item | Example 12 | Example 13 |
| Peel strength [gf/25 mm] at 25 °C | ⊚ | ⊚ |
| Peel strength [gf/25 mm] at 60 °C | ◯ | ◯ |
| Peel strength [gf/25 mm] at 85 °C/ | X | X |
| 85% RH | | |

Referring to the evaluation results of Examples and Comparative Examples in Tables 12 to 17, it is seen that Examples 1 to 24, i.e., resin compositions including the first copolymer or the second copolymer, all exhibit excellent or suitable adherence under all conditions of room temperature (25 °C), high temperature (60 °C), and high temperature and high humidity (85 °C/85% RH) in the measurement results of peel specimens prepared through light irradiation in the air atmosphere. This is considered to be the result of segregation of the copolymer on an outermost surface during photocuring of the resin composition, thereby maintaining adhesion (adherence) by a certain cohesion, and interactions with the resin matrix being imparted through a photocationic reaction by an epoxy group or an oxetane group within the copolymer.

In comparison, Comparative Example 1, a composition containing neither the first copolymer nor the second copolymer, failed to exhibit the desired adhesion at room temperature, high temperature, or high humidity environments. This result in Comparative Example 1 is attributed to the insufficient adhesion caused by the inhibition of curing at an outermost surface due to the influence of oxygen in the air atmosphere during photocuring.

In addition, the resin compositions of Comparative Examples 2 to 5 each exhibited relatively satisfactory adhesion (adherence) at room temperature, but exhibited significantly reduced adhesion at high temperature (60 °C) and high temperature and high humidity (85 °C/85% RH). These results are because, although adhesion (adherence) was maintained similarly to Examples near room temperature, the overall cohesion was lost because the copolymer does not contain a cationically reactive group, resulting in weak interaction with the matrix and an extremely high increase in fluidity at high temperatures, and also because high humidity caused water penetration between the cured layer and the substrate, thereby making peeling easier.

In addition, the resin compositions of Comparative Examples 6 to 9 each exhibited relatively satisfactory adhesion (adherence) at high temperature (60 °C) and high temperature and high humidity (85 °C/85% RH), but all failed to exhibit adhesion at room temperature. These results are because the cationically reactive groups within the copolymer were excessive, leading to a very high crosslinking density within the matrix even with a small amount of addition (V-601), consequently hardening the resin surface and failing to exhibit adherence.

In addition, the resin compositions of Comparative Examples 10 to 13 each exhibited relatively satisfactory adhesion (adherence) at room temperature, but all exhibited significantly reduced adhesion particularly at high temperature and high humidity (85 °C/85% RH). These results are because overall cohesion was reduced due to fluidity at high temperatures, which resulted from insufficient interaction with the matrix even with a large amount of addition (V-601) because there are few cationic reactive groups in the copolymer, and because high humidity caused water penetration between the cured layer and the substrate, thereby making peeling easier.

A resin composition according to one or more embodiments includes a (meth)acrylate copolymer of (e.g., polymerized by including) a cationically reactive (meth)acrylate monomer containing an epoxy group or an oxetane group and a non-cationically reactive (meth)acrylate monomer, and may thus reduce the inhibition of curing by oxygen during photocuring in an oxygen-containing atmosphere, thereby providing an effect of preventing or reducing a decrease in adhesive strength. In addition, the resin compositions according to one or more embodiments may exhibit excellent or suitable adhesive strength at room temperature and also at high-temperature and high-humidity conditions during curing.

An adhesive member according to one or more embodiments is formed from the resin composition according to one or more embodiments, and may thus exhibit excellent or suitable adhesive properties at room temperature, high-temperature, and high-temperature and high-humidity conditions.

An electronic device according to one or more embodiments includes the adhesive member according to one or more embodiments, and may thus exhibit excellent or suitable reliability.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, ±20%, ±10%, or ±5% of the stated value. Also, it should be understood that, even if the terms “about,” “approximately,” or “substantially” are not expressly recited in a given element (e.g., a claim element), the scope of such element is intended to include variations that are insubstantial or within the understanding of one of ordinary skill in the art. For example, numerical values and ranges provided herein are intended to include tolerances and measurement uncertainties that would be recognized by those skilled in the art, and the elements (e.g., claim elements) should be construed accordingly to encompass such equivalents.

In the context of the present application and unless otherwise defined, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this disclosure, including the claims, to expressly recite any sub-range subsumed within the ranges expressly recited herein.

The light emitting element, the display device, the display module, the display panel, the electronic device/apparatus, the manufacturing apparatus thereof, or any other relevant apparatuses/devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

In the present disclosure, each suitable feature of the various embodiments of the disclosure may be combined or combined with each other, partially or entirely, and may be technically interlocked and operated in various suitable ways, and each embodiment may be implemented independently of each other or in conjunction with each other in any suitable manner unless otherwise stated or implied.

In the above, description has been made with reference to one or more embodiments of the disclosure, but those skilled or of ordinary skill in the art may understand that one or more suitable modifications and changes may be made to the disclosure insofar as such modifications and changes do not depart from the spirit and technical scope of the disclosure set forth in the appended claims.

Therefore, the technical scope of the present disclosure is not to be limited to the content stated in the detailed description of the disclosure, but should be determined by the claims and equivalents thereof.

What is claimed is:

1. A resin composition, comprising:
a (meth)acrylate copolymer, the (meth)acrylate copolymer being a first copolymer or a second copolymer;
a monofunctional (meth)acrylate monomer;
a photoradical polymerization initiator; and
a photocationic polymerization initiator,
wherein the first copolymer is a copolymer of a first monomer which is a cationically reactive (meth)acrylate monomer containing an epoxy group and a third monomer which is a non-cationically reactive (meth)acrylate monomer,
the second copolymer is a copolymer of a second monomer which is a cationically reactive (meth)acrylate monomer containing an oxetane group, and the third monomer,
the first copolymer is a copolymer of the first monomer in an amount of 1 part to 30 parts by mass with respect to 100 parts by mass of a total of the first monomer and the third monomer, and
the resin composition does not comprise any cationically reactive compound other than the first monomer or the second monomer comprised in the polymerization of the (meth)acrylate copolymer.

2. The resin composition of claim 1, wherein the (meth)acrylate copolymer has a weight average molecular weight of 3,000 to 30,000.

3. The resin composition of claim 1, wherein the (meth)acrylate copolymer is in an amount of 5 parts to 50 parts by mass with respect to 100 parts by mass of the monofunctional (meth)acrylate monomer.

4. The resin composition of claim 1, wherein the first monomer comprises at least one of glycidyl methacrylate, glycidyl acrylate, (3,4-epoxycyclohexyl)methyl acrylate, or (3,4-epoxycyclohexyl)methyl methacrylate, and
the second monomer comprises at least one of (3-ethyloxetan-3-yl)methyl acrylate or (3-ethyloxetan-3-yl)methyl methacrylate.

5. The resin composition of claim 1, wherein the third monomer comprises at least one of methyl methacrylate or isobornyl methacrylate.

6. The resin composition of claim 1, wherein the first copolymer is a copolymer of the first monomer, methyl methacrylate, and isobornyl methacrylate.

7. The resin composition of claim 6, wherein the first monomer is glycidyl methacrylate or (3,4-epoxycyclohexyl)methyl methacrylate.

8. The resin composition of claim 1, wherein the second copolymer is a copolymer of the second monomer, methyl methacrylate, and isobornyl methacrylate.

9. The resin composition of claim 8, wherein the second monomer is (3-ethyloxetan-3-yl)methyl methacrylate.

10. The resin composition of claim 1, wherein the monofunctional (meth)acrylate monomer comprises at least one of 4-hydroxybutylacrylate, 2-ethylhexylacrylate, or tetrahydrofurfuryl acrylate.

11. The resin composition of claim 1, wherein the photocationic polymerization initiator comprises a borate and/or a sulfonate.

12. An adhesive member derived from a resin composition cured by light irradiation in an air atmosphere,
wherein the resin composition comprises:
a (meth)acrylate copolymer, the (meth)acrylate copolymer being a first copolymer or a second copolymer;
a monofunctional (meth)acrylate monomer;
a photoradical polymerization initiator; and
a photocationic polymerization initiator,
wherein the first copolymer is a copolymer of a first monomer which is a cationically reactive (meth)acrylate monomer containing an epoxy group and a third monomer which is a non-cationically reactive (meth)acrylate monomer,
the second copolymer is a copolymer of a second monomer which is a cationically reactive (meth)acrylate monomer containing an oxetane group, and the third monomer,
the first copolymer is a copolymer of the first monomer in an amount of 1 part to 30 parts by mass with respect to 100 parts by mass of a total of the first monomer and the third monomer, and
the resin composition does not comprise any cationically reactive compound other than the first monomer or the second monomer comprised in the polymerization of the (meth)acrylate copolymer.

13. The adhesive member of claim 12, having a 180° peel strength of 800 gf/25 mm or greater for at least one of a glass substrate or a polymer substrate at a temperature of 25 °C.

14. The adhesive member of claim 12, having a 180° peel strength of 200 gf/25 mm or greater for at least one of a glass substrate or a polymer substrate at a temperature of 60 °C.

15. The adhesive member of claim 12, having a 180° peel strength of 100 gf/25 mm or greater for at least one of a glass substrate or a polymer substrate at a temperature of 85 °C and a relative humidity of 85%.

16. The adhesive member of claim 12, wherein the (meth)acrylate copolymer has a weight average molecular weight of 3,000 to 30,000.

17. The adhesive member of claim 12, wherein the (meth)acrylate copolymer is in an amount of 5 parts to 50 parts by mass with respect to 100 parts by mass of the monofunctional (meth)acrylate monomer.

18. An electronic device, comprising a display device comprising at least one adhesive member derived from a resin composition,
wherein the resin composition comprises:
a (meth)acrylate copolymer, the (meth)acrylate copolymer being a first copolymer or a second copolymer;
a monofunctional (meth)acrylate monomer;
a photoradical polymerization initiator; and
a photocationic polymerization initiator,
wherein the first copolymer is a copolymer of a first monomer which is a cationically reactive (meth)acrylate monomer containing an epoxy group and a third monomer which is a non-cationically reactive (meth)acrylate monomer,
the second copolymer is a copolymer of a second monomer which is a cationically reactive (meth)acrylate monomer containing an oxetane group, and the third monomer,
the first copolymer is a copolymer of the first monomer in an amount of 1 part to 30 parts by mass with respect to 100 parts by mass of a total of the first monomer and the third monomer, and
the resin composition does not comprise any cationically reactive compound other than the first monomer or the second monomer comprised in the polymerization of the (meth)acrylate copolymer.

19. The electronic device of claim 18, wherein the display device further comprises a display panel configured to display images and a window arranged on the display panel, and
the adhesive member is between the display panel and the window.

20. The electronic device of claim 18, wherein the electronic device is at least one of a television, a monitor, an outdoor billboard, a personal computer, a laptop computer, a personal digital terminal, an in-vehicle device, a game console, a smartphone, a tablet, a smartwatch, or a camera.
